(19) United States
(12) Patent Application Publication
(10) Pub. No.: US 2025/0360564 A1
(43) Pub. Date: Nov. 27, 2025

(54) METHOD OF CONTROLLING MICROSTRUCTURE OF NICKEL-BASED SUPERALLOY DIRECTED ENERGY DEPOSITION STRUCTURE

(71) Applicant: DONG-A UNIVERSITY RESEARCH FOUNDATION FOR INDUSTRY-ACADEMY COOPERATION, Busan (KR)

(72) Inventors: Jong Bae JEON, Busan (KR); Deok Hyun JO, Busan (KR); Jae Jun LEE, Busan (KR); Hak Sung LEE, Busan (KR); Geon Woo PARK, Yangsan-si (KR)

(21) Appl. No.: 19/065,959

(22) Filed: Feb. 27, 2025

(30) Foreign Application Priority Data
May 27, 2024 (KR) 10-2024-0068637

(51) Int. Cl. B22F 10/366; B22F 10/25; B33Y 10/00; B33Y 50/02; B33Y 70/10

(52) U.S. Cl. CPC B22F 10/366; B22F 10/25; B33Y 10/00; B33Y 50/02; B33Y 70/10; B22F 2301/15; B22F 2302/25; B22F 2304/054; B22F 2304/056; B22F 2304/10

(57) ABSTRACT

Provided a method of controlling microstructure of nickel-based superalloy directed energy deposition structure to obtain microstructural refinement, uniformity, and high hardness. The method of controlling microstructure of directed energy deposition structure includes, providing a mixed powder comprising a nickel-based superalloy powder and a zirconia nano-powder; forming a nickel-based superalloy directed energy deposition structure by performing directed energy deposition with the mixed powder using a laser with a process variable; and establishing a correlation between microstructure and an internal variable of the nickel-based superalloy directed energy deposition structure.

### CROSS-REFERENCE TO RELATED PATENT APPLICATION

This application claims the benefit of Korean Patent Applications No. 10-2024-0068637, filed on May 27, 2024, in the Korean Intellectual Property Office, the disclosure of which is incorporated herein in its entirety by reference.

### BACKGROUND OF THE INVENTION

### 1. Field of the Invention

The present invention relates to a nickel-based superalloy structure, and more particularly, to a method of controlling microstructure of a nickel-based superalloy directed energy deposition structure to obtain microstructural refinement, uniformity, and high hardness.

The present invention is proposed with reference to Development of localized manufacturing technology of metal powder for HRC grade 60 mold steel and dissimilar metal additive manufacturing technology for high strength material molding, No. 1415186063 (20011279) supported by the Korea Institute for Advancement of Technology (KEIT), granted financial resource from the Ministry of Trade, Industry and Energy, Republic of Korea, and to Establishment of an aerospace superalloys HUB with materials database-driven artificial intelligence technology, No. 2710018197 (00451579) supported by the National Research Foundation of Korea from the Ministry of Science and ICT, Republic of Korea.

### 2. Description of the Related Art

Directed energy deposition (DED) three-dimensional printing is a technology that creates three-dimensional shape as digital design data through computer modeling, differentiates it into a two-dimensional plane, prints the differentiated material on the plane using a three-dimensional printer, and continues to stack the printed data layer-by-layer to create a three-dimensional product. The directed energy deposition, which is applied to form metal structures, creates final products by spraying metal powder onto a base material, melting the base material and the metal powder simultaneously, and attaching and depositing them one layer at a time. In the directed energy deposition process, while applying high-power laser, metal powder is simultaneously sprayed around the laser, thereby melting and solidifying the metal powder to form a two-dimensional metal layer. Then, the metal layer is melted by a continuously applied laser, and a metal powder sprayed is simultaneously melted, thereby continuously overlaying single layers on the metal layer. This process is repeatedly performed to produce a three-dimensional stacked structure. Therefore, in the directed energy deposition method, process variables can be controlled in real time.

However, the directed energy deposition method may cause grain coarsening of the deposition structure due to the high heat input by the laser. When grains of the deposition structure are coarsened, it will have a negative effect on properties such as tensile property, creep strength, and fracture toughness. In addition, coarsened grains may result in a strong aggregate structure of crystal orientation, causing anisotropy in mechanical properties. Therefore, it is necessary to minimize porosity and refine the grain structure. For this purpose, a method to control the microstructure is required.

### SUMMARY OF THE INVENTION

The present invention provides a method of controlling microstructure of a nickel-based superalloy directed energy deposition structure to obtain microstructural refinement, uniformity, and high hardness.

However, the above description is an example, and the scope of the present invention is not limited thereto.

According to one aspect of the present invention, there is provided a method of controlling microstructure of a nickel-based superalloy directed energy deposition structure to obtain microstructural refinement, uniformity, and high hardness.

According to an embodiment of the present invention, the method of controlling microstructure of a nickel-based superalloy directed energy deposition structure may include: providing a mixed powder comprising a nickel-based superalloy powder and a zirconia nano-powder; forming a nickel-based superalloy directed energy deposition structure by performing directed energy deposition with the mixed powder using a laser with a process variable; and establishing a correlation between microstructure and an internal variable of the nickel-based superalloy directed energy deposition structure.

According to an embodiment of the present invention, a method of controlling microstructure of a nickel-based superalloy directed energy deposition structure may include: providing a powder; forming a directed energy deposition structure by performing directed energy deposition with the powder using a laser with a process variable; and establishing a correlation between microstructure and an internal variable of the directed energy deposition structure.

### BRIEF DESCRIPTION OF THE DRAWINGS

The above and other features and advantages of the present invention will become more apparent by describing in detail embodiments thereof with reference to the attached drawings in which:

FIG. 1 shows a schematic diagram of a directed energy deposition apparatus for performing a method of controlling microstructure of a nickel-based superalloy directed energy deposition structure, according to an embodiment of the present invention.

FIG. 2 shows a flow chart of a method of controlling microstructure of a nickel-based superalloy directed energy deposition structure, according to an embodiment of the present invention.

FIG. 3 shows microstructures of powders used in a method of controlling microstructure of a nickel-based superalloy directed energy deposition structure, according to an embodiment of the present invention.

FIG. 4 shows graphs of reflectance of powders used in a method of controlling microstructure of a nickel-based superalloy directed energy deposition structure, according to an embodiment of the present invention.

FIG. 5 shows a method of measuring a melt pool volume in a deposition structure formed by a method of controlling microstructure of a nickel-based superalloy directed energy deposition structure, according to an embodiment of the present invention.

FIGS. 6 and 7 show photographs of surfaces of deposition structures formed by a method of controlling microstructure of a nickel-based superalloy directed energy deposition structure, according to an embodiment of the present invention.

FIG. 8 shows a schematic diagram of hatch distances in a method of controlling microstructure of a nickel-based superalloy directed energy deposition structure, according to an embodiment of the present invention.

FIGS. 9A and 9B show graphs of average porosity with respect to energy density of a deposition structure formed by a method of controlling microstructure of a nickel-based superalloy directed energy deposition structure, according to an embodiment of the present invention.

FIG. 10 shows photographs of the microstructure of deposition structures formed by a method of controlling microstructure of a nickel-based superalloy directed energy deposition structure, according to an embodiment of the present invention.

FIGS. 11A to 14 show information for deriving correlations for the microstructures of deposition structures formed by a method of controlling microstructure of a nickel-based superalloy directed energy deposition structure, according to an embodiment of the present invention.

FIGS. 15 and 16 show results of analyzing precipitates in deposition structures formed by a method of controlling microstructure of a nickel-based superalloy directed energy deposition structure, according to an embodiment of the present invention.

FIG. 17 shows a graph of hardness of deposition structures formed by a method of controlling microstructure of a nickel-based superalloy directed energy deposition structure, according to an embodiment of the present invention.

FIGS. 18 to 24 show information for explaining microstructure development factors for a deposition structure formed by a method of controlling microstructure of a nickel-based superalloy directed energy deposition structure, according to an embodiment of the present invention.

FIGS. 25A to 26 show graphs for deriving correlations for the microstructures of deposition structures formed by a method of controlling microstructure of a nickel-based superalloy directed energy deposition structure, according to an embodiment of the present invention.

### DETAILED DESCRIPTION OF THE INVENTION

Hereinafter, the present invention will be described in detail by explaining embodiments of the invention with reference to the attached drawings. The invention may, however, be embodied in many different forms and should not be construed as being limited to the embodiments set forth herein, rather, these embodiments are provided so that this disclosure will be thorough and complete, and will fully convey the concept of the invention to one of ordinary skill in the art. Like reference numerals refer to like elements throughout. Further, various elements and regions in the drawings are schematically illustrated. Therefore, the scope of the present invention is not limited by the relative sizes or distances shown in the attached drawings.

Nickel-based superalloys are excellent materials with good heat resistance, as they have excellent corrosion resistance, high-temperature strength, and high-temperature creep properties. They also have excellent strength and toughness at cryogenic temperatures. Because of these advantages, it is important material that is used in a variety of industries, including the aerospace and nuclear power industries. Nickel-based superalloys come in a variety of types, including Hastelloy, Monel, Inconel, and NILO, Inconel 718 and Inconel 625 are two of the most widely used nickel-based superalloys in the aerospace industry. The Inconel 718 is a precipitation-hardening superalloy based on Ni—Cr—Fe, and has excellent corrosion resistance and excellent mechanical properties at high temperature and cryogenic temperature. Thus, Inconel 718 is widely used in the manufacture of gas turbines, jet engines, and rocket motors due to its excellent properties and the industrial demand for Inconel 718 is continuing to grow.

However, Inconel 718 has the disadvantages of being hard and difficult to machine, resulting in high machining costs and high replacement costs for damaged parts. In this regard, the directed energy deposition (DED) process, which is useful for repair and maintenance in additive manufacturing (AM), can save machining costs and process costs by reducing the amount of material lost. In addition, it can save the cost of replacing damaged parts because it is useful for surface treatment and repair of damaged area, the deposition speed is faster than the powder bed fusion (PBF) process, and it has the advantages of being able to produce large parts and deposit on arbitrary surface morphologys. For this reason, research on surface strengthening and repair using DED for high-cost parts such as nickel-based superalloys is currently receiving attention.

However, DED process causes columnar grain growth and grain coarsening due to high heat input, thereby adversely affecting tensile properties, creep strength, and fracture toughness of the product. In addition, the strong texture of the crystallographic orientation caused by the columnar grain growth and coarsening can induce anisotropy of the mechanical properties. There are various mechanisms to address the columnar grain growth and coarsening of deposition structures. One approach is to change the deposition process variables, but no reports have been published on the on the refinement of grain size and the transition from columnar to equiaxed grains through this method. Previous studies on the effects of the grain refinement and the formation of equiaxed grains have used rolling, hot isostatic pressing (HIP), shot peening, ultrasonic, magnetic field, and inoculant.

The methods for the grain refinement and the formation of equiaxed grains by additives (inoculation) will be described. First, it is to utilize the heterogeneous nucleation by additives. The nanoparticle inoculation effect provides nucleation sites, leading to the grain refinement during solidification. In this case, heterogeneous nucleation can contribute to the grain refinement by narrowing the spacing of dendrite arm spacing (DAS) or secondary dendrite arm spacing (SADS). Second, it is to utilize the grain boundary pinning effect. Additives or precipitates are pinned at grain boundaries, suppressing grain growth during cooling and leading to the grain refinement. Third, it is to control G×R (cooling rate), G (temperature gradient)/R (solidification rate) by additives. When the G×R increases and the G/R is decrease, the nucleation behavior increases, and the R value increases, leading to the grain refinement and the formation of equiaxed grains.

In addition, by mixing nanoparticles, the grain refinement may be achieved, and crystal orientation anisotropy may be suppressed. In previous studies, nanoparticles added for the grain refinement are carbides, oxides, or carbon nanotubes. The nanoparticles added to nickel-based superalloy are TiC, WC, Y₂O₃, and carbon nanotubes. In the powder bed melting process, TiC, WC, Y₂O₃, and CNT are applied, and in the directed energy deposition process, TiC is applied. The selection of additives for inducing nucleation needs to consider low melting point, consistency between primary phase and matrix phase, and added nanoparticle cost.

In the present invention, as added nanoparticles, Zirconia (ZrO₂) is selected. The melting point of ZrO₂ is 2700° C., which is lower than that of WC (2870° C.). ZrO₂ has advantages over Y₂O₃, which is composed of rare earth elements, in terms of material supply and cost. Additionally, there has been little research of ZrO₂ addition to nickel-based superalloys. Therefore, it is highly valuable to study the effects of ZrO₂ addition on the grain refinement and texture anisotropy of nickel-based superalloys. The present invention investigated the effects of mixing Inconel 718 powder with ZrO₂ nanoparticles on the grain refinement, the formation of equiaxed grains, and mechanical properties. It also investigated the effects of ZrO₂ nanoparticles content and process variables used in deposition on the effects of the grain refinement. The mechanisms of the formation of equiaxed grains and the grain refinement are analyzed.

According to the present invention, a method of controlling microstructure of a nickel-based superalloy directed energy deposition structure is provided. According to the method, variables correlated with the microstructure of the nickel-based superalloy directed energy deposition structure are derived and set, thereby forming a target nickel-based superalloy directed energy deposition structure having a target microstructure.

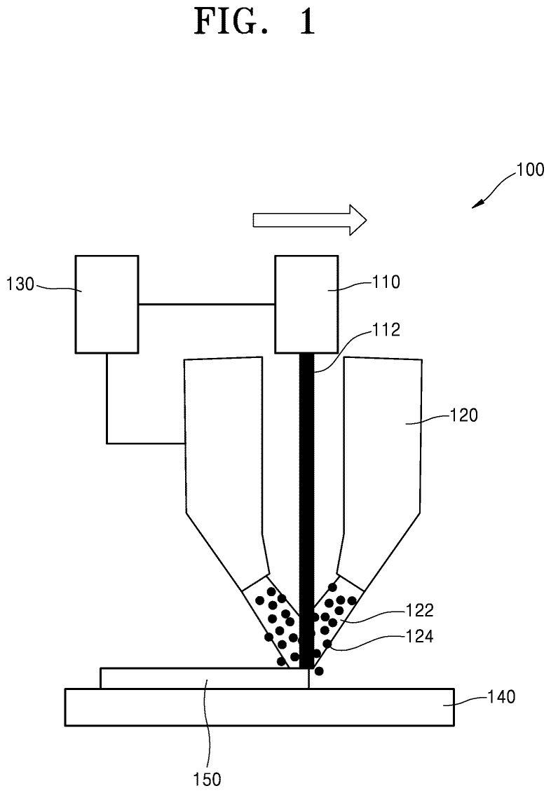

FIG. 1 shows a schematic diagram of a directed energy deposition apparatus for performing a method of controlling microstructure of a nickel-based superalloy directed energy deposition structure, according to an embodiment of the present invention.

Referring to FIG. 1, the directed energy deposition apparatus 100 includes a laser unit 110, a powder providing unit 120, and a control unit 130.

The powder providing unit 120 may provide a powder onto a base material 140.

The laser unit 110 may provide a laser to the powder.

The control unit 130 may control the operations of the laser unit 110 and the powder providing unit 120. The control unit 130 may control a laser power, a laser scan speed, and a laser energy density, etc. of the laser unit 110. In addition, the control unit 130 may control an amount, a fraction, and a supply speed, etc. of the powder of the powder providing unit 120.

A powder 124 is provided from the powder providing unit 120 by a carrier gas 122, and at the same time, a laser 112 is provided by the laser unit 110, and then the mixed powder 124 is melted by the laser 112, thereby forming a deposition structure 150 on the base material 140. The laser unit 110 may move in the direction of an arrow, and accordingly, the deposition structure 150 may be formed at a location where the laser unit 110 has passed.

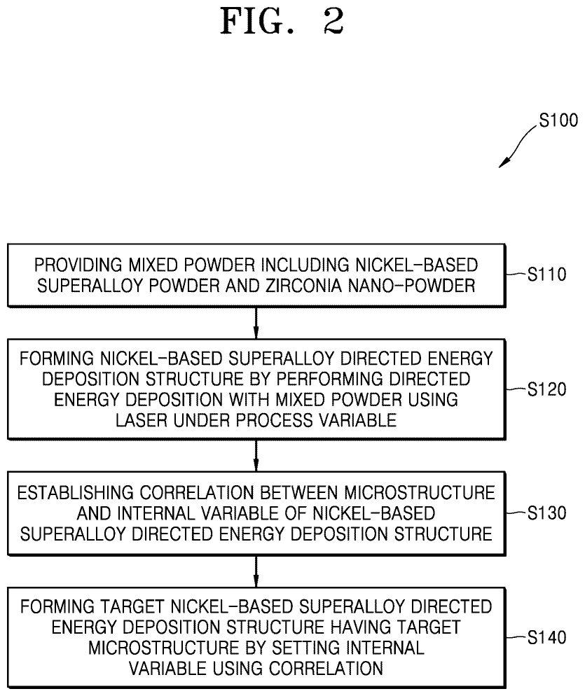

FIG. 2 shows a flow chart of a method of controlling microstructure of a nickel-based superalloy directed energy deposition structure, according to an embodiment of the present invention.

Referring to FIG. 2, the method of controlling microstructure of the nickel-based superalloy directed energy deposition structure S100 includes: providing a mixed powder comprising a nickel-based superalloy powder and a zirconia nano-powder S110; forming a nickel-based superalloy directed energy deposition structure by performing directed energy deposition with the mixed powder using a laser with a process variable S120; and establishing a correlation between microstructure and an internal variable of the nickel-based superalloy directed energy deposition structure S130.

In addition, the method of controlling microstructure of the nickel-based superalloy directed energy deposition structure S100 may further include: forming a target nickel-based superalloy directed energy deposition structure having a target microstructure by setting the internal variable using the correlation S140.

The forming a target nickel-based superalloy directed energy deposition structure S140 may be performed by deriving a process variable from the internal variable, and performing directed energy deposition with the mixed powder under the derived process variable to form the target nickel-based superalloy directed energy deposition structure.

The process variable may include at least one of a laser power, a scan speed, and a laser energy density during the performing directed energy deposition.

The internal variable may include at least one of a volume energy density, a Fourier number, a Marangoni convection value, and a contact ratio.

The volume energy density is the value of the obtained by dividing the laser energy density by the volume of the melt pool formed by laser irradiation, as shown in Equation 1 below.

$$[ volume energy density ] = [ laser energy density ] / [ volume of melt pool ] \qquad [ Equation 1 ]$$

The volume energy density may be, for example, in the range of more than 0 J/mm³ to equal to or less than 0.1 J/mm³.

The contact ratio is the value obtained by dividing the cross-sectional area of the melt pool in contact with the substrate or parent material by the cross-sectional area of the entire melt pool, as shown in Equation 2 below.

$$[ contact ratio ] = [ area of melt pool contacting parent material ] / [ total area of melt pool ] \qquad [ Equation 2 ]$$

The contact ratio may be, for example, in the range of more than 0 to less than 1. The contact ratio may be, for example, in the range of more than equal to or more than 0.5 to less than 1.

The Marangoni convection value is a dimensionless value that generally compares the movement speed by Marangoni flow and the movement speed by diffusion. Note that there are no units since flow and diffusion time scales are compared.

The Marangoni convection value may satisfy the following equation 3:

$$[ Marangoni convection ] = ( dT / d γ ) \times ( w Δ T / μα ) \qquad [ Equation 3 ]$$

Here, T is temperature of a melt pool, γ is surface tension, w is a width of the melt pool, ΔT is difference between maximum temperature and solidus temperature of the melt pool, μ is viscosity of the melt pool, and α is thermal diffusivity of the melt pool.

The Marangoni convection value may be, for example, in the range of more than 0 to equal to or less than 5.

The Fourier number is a dimensionless number that represents a time scale during heat dissipation process and is used as a measure to compare the heat dissipation rate and heat storage rate of a material.

The Fourier number may satisfy the following equation 4:

$$[ Fourier number ] = α / ( V \times L ) \qquad [ Equation 4 ]$$

Here, α is thermal diffusivity of a melt pool, V is a scan speed, and L is a length of the melt pool.

The Fourier number may be, for example, in the range of more than 0 to equal to or less than 0.1.

A microstructure of the nickel-based superalloy directed energy deposition structure may include at least one of a columnar grain structure, an equiaxed grain structure, a mixed structure of columnar grains and equiaxed grains, and an amorphous structure.

A target a microstructure of the target nickel-based superalloy directed energy deposition structure may include at least one of a columnar grain structure, an equiaxed grain structure, a mixed structure of columnar grains and equiaxed grains, and an amorphous structure.

The nickel-based superalloy powder may have a first average particle size. The zirconia nano-powder may have a second average particle size smaller than the first average particle size.

For example, the nickel-based superalloy powder may have an average particle size in the range of 45 μm to 150 μm. The zirconia nano-powder may have an average particle size in the range of 20 nm to 200 nm.

The mixed powder may include the nickel-based superalloy powder in the range of 98 wt % to 99 wt % and the zirconia nano-powder in the range of 1 wt % to 2 wt %.

The nickel-based superalloy powder may include Inconel 718 powder.

The nickel-based superalloy powder may include, based on the total weight of the nickel-based superalloy powder, 50 wt % to 55 wt % of nickel (Ni), 17 wt % to 21 wt % of chromium (Cr), 4.75 wt % to 5.50 wt % of niobium (Nb), 2.8 wt % to 3.30 wt % of molybdenum (Mo), 0.65 wt % to 1.15 wt % of titanium (Ti), 0.20 wt % to 0.80 wt % of aluminum (Al), 0.1 wt % to 1 wt % of cobalt (Co), and a remainder including iron and inevitable impurities.

In addition, the nickel-based superalloy powder may further include, based on the total weight of the nickel-based superalloy powder, at least one of equal to or less than 0.8 wt % of carbon (C), equal to or less than 0.35 wt % of manganese (Mn), equal to or less than 0.35 wt % of silicon (Si), equal to or less than 0.3 wt % copper (Cu), equal to or less than 0.015 wt % of phosphorus (P), and equal to or less than 0.015 wt % of sulfur(S).

In addition, the nickel-based superalloy powder may further include, based on the total weight of the nickel-based superalloy powder, at least one of more than 0 wt % to equal to or less than 0.8 wt % of carbon (C), more than 0 wt % to equal to or less than 0.35 wt % of manganese (Mn), more than 0 wt % to equal to or less than 0.35 wt % of silicon (Si), more than 0 wt % to equal to or less than 0.3 wt % copper (Cu), more than 0 wt % to equal to or less than 0.015 wt % of phosphorus (P), and more than 0 wt % to equal to or less than 0.015 wt % of sulfur(S).

The inevitable impurities cannot be excluded because unintended impurities may inevitably be mixed in from raw materials or the surrounding environment during a conventional manufacturing process. Since these impurities may be known to anyone skilled in the art of conventional manufacturing processes, not all the contents are specifically mentioned in this specification.

The mixed powder may be formed by mixing the nickel-based superalloy powder and the zirconia nano-powder at a mixing speed, for example, in the range of 600 RPM (round per minute) to 800 RPM, for example, for 1 to 10 minutes.

The forming the nickel-based superalloy directed energy deposition structure S120 may be performed with a laser power, for example, in the range of 100 W to 500 W and a laser scan speed, for example, in the range of 200 mm/min to 2000 mm/min. The forming the nickel-based superalloy directed energy deposition structure S120 may be performed with a laser energy density, for example, in the range of 109 J/mm to 1000 J/mm.

For example, the laser power may be in the range of 200 W to 350 W. The laser scan speed may be in the range of 600 mm/min to 1000 mm/min. The laser energy density may be in the range of 179 J/mm to 417 J/mm.

The nickel-based superalloy directed energy deposition structure may include nickel-based superalloy in the range of 98 wt % to 99 wt % and zirconia in the range of 1 wt % to 2 wt %.

The nickel-based superalloy directed energy deposition structure may have a porosity, for example, in the range of more than 0 volume % to equal to or less than 1.0 volume %. The nickel-based superalloy directed energy deposition structure may have a porosity, for example, in the range of more than 0 volume % to equal to or less than 0.6 volume %.

The nickel-based superalloy directed energy deposition structure may have a Vickers hardness, for example, in the range of 220 Hv to 300 Hv. The nickel-based superalloy directed energy deposition structure may have a Vickers hardness, for example, in the range of 270 Hv to 300 Hv.

The nickel-based superalloy directed energy deposition structure may include equiaxed grains with an average graine size, for example, in the range of 10 μm to 100 μm.

The nickel-based superalloy directed energy deposition structure may include Al₃Zr intermetallic compounds.

According to the present invention, the method of controlling microstructure of a nickel-based superalloy directed energy deposition structure may be extended to any deposition structure formed by applying the directed energy deposition method using various powders.

Accordingly, a method of controlling microstructure of a directed energy deposition structure according to an embodiment of the present invention may include providing a powder; forming a directed energy deposition structure by performing directed energy deposition with the powder using a laser with a process variable; and establishing a correlation between microstructure and an internal variable of the directed energy deposition structure.

In addition, the method of controlling microstructure of a directed energy deposition structure may further include forming a target nickel-based superalloy directed energy deposition structure having a target microstructure by setting the internal variable using the correlation.

### Experimental Example

The following experimental examples are described to help understand the present invention. The following experimental examples are presented to help understand the invention, and the present invention is not limited to the following experimental examples.

Raw materials for powders according to an embodiment of the present invention were prepared. The nickel-based superalloy powder was Inconel 718 with a particle size in the range of 45 μm to 150 μm. The zirconia nano-powder was prepared as zirconia nano powder having an average particle size (or particle diameter) of 20 nm.

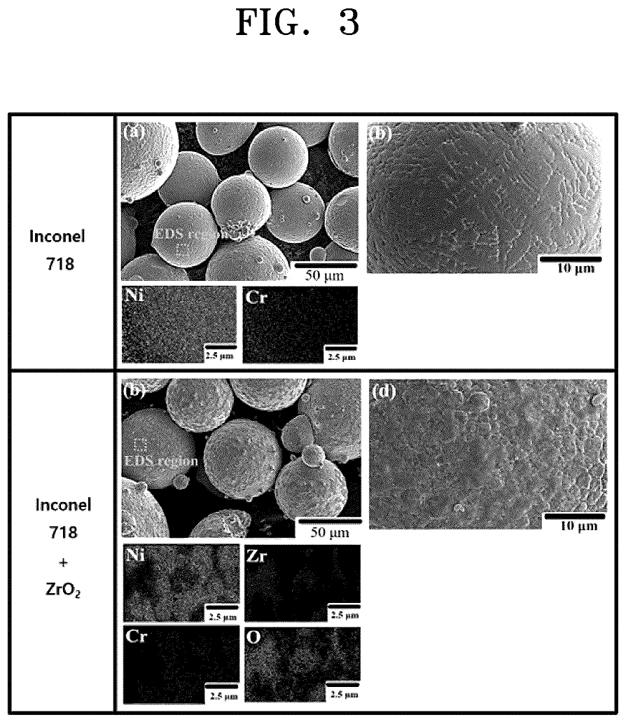

FIG. 3 shows microstructures of powders used in a method of controlling microstructure of a nickel-based superalloy directed energy deposition structure, according to an embodiment of the present invention.

Referring to FIG. 3, Field emission-scanning electron microscopy (FE-SEM, JSM-6700F, JEOL, Japan) photographs and the results of energy dispersive spectroscopy (EDS) for the Inconel 718 powder and the mixed powder of Inconel 718 powder and zirconia (ZrO₂) powder are shown.

The Inconel 718 powder (Koswire, Republic of Korea) is a spherical particle with a purity of equal to or more than 99%, a particle size ranging from 45 μm to 150 μm, and an average particle size of 45.8 μm. The Inconel 718 powder included, based on the total weight of the Inconel 718 powder, 53.50 wt % of nickel (Ni), 18.07 wt % of chromium (Cr), 18.27 wt % of iron (Fe), 5.16 wt % of niobium (Nb), 2.98 wt % of molybdenum (Mo), 0.07 wt % of manganese (Mn), 0.08 wt % of silicon (Si), 0.93 wt % of titanium (Ti), 0.52 wt % of aluminum (Al), and 0.23 wt % of cobalt (Co).

The zirconia nano-powder (RND Korea, Republic of Korea) had a purity of 99.9% and an average particle size of 200 nm.

The mixed powder was formed by mixing 98 wt % of the Inconel 718 powder and 2 wt % of the zirconia nano-powder at a mixing speed of 700 RPM for 5 minutes using a swing planetary mixer (HSPM-1.5, Han Tech, Republic of Korea). The mixed powder maintained a spherical particle shape and had an average particle size of 53.8 μm. Compared to the Inconel 718 powder, the mixed powder was mixed without significant changes in physical properties such as size and sphericity, but had uneven surface roughness. The average particle size of the mixed powder increased somewhat compared to the Inconel 718 powder.

From the EDS results, the mixed powder has the same components as the Inconel 718 powder, such as nickel and chromium. It may be confirmed that zirconia nanoparticles are dispersed on the surface of the Inconel 718 powder.

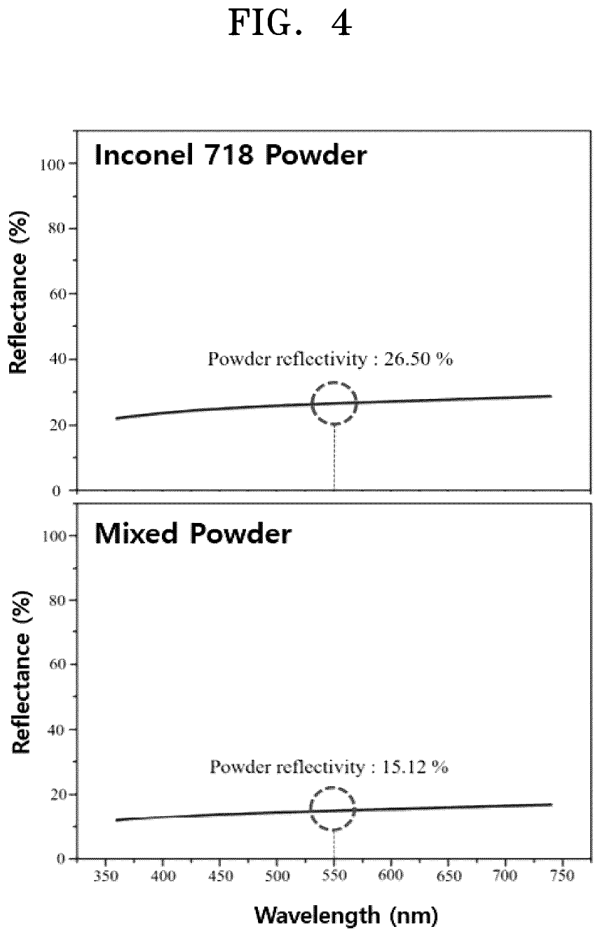

FIG. 4 shows graphs of reflectance of powders used in a method of controlling microstructure of a nickel-based superalloy directed energy deposition structure, according to an embodiment of the present invention.

Referring to FIG. 4, reflectance of the Inconel 718 powder and the mixed powder are shown, measured using a spectrophotometer (CM-5, KONICA MINOLTA, Japan). The measurement conditions of the reflectance were a light source of a xenon lamp D65, a field of view angle of 10 degrees, wavelength range of 360 nm to 740 nm, and wavelength interval of 10 nm, and three times measurements. At a wavelength of 550 nm, the Inconel 718 powder shows reflectance values of 26.52%, 26.50%, and 26.49%, and an average reflectance of 26.50%, The mixed powder shows reflectance values of 15.10%, 15.12%, and 15.13%. and an average reflectance of 15.12%. Analyzing the reflectance results, the Inconel 718 powder has a uniform surface roughness, but the mixed powder has a relatively low reflectance and uneven surface roughness. Thus, when the zirconia nano-powder is added, zirconia particles are dispersed on the surface to deteriorate surface roughness, thereby changing heat input and laser absorption rate, for example, decreasing heat input and laser absorption rate.

The directed energy deposition apparatus used in the experiment is MX-Lab (Insstek, Korea) equipped with a 500-watt fiber laser. The maximum beam diameter is 400-μm. It is also equipped with a 3-axis CNC table and a coaxial conical powder supply nozzle. The X/Y/Z stroke is 150 mm×150 mm×150 mm. The MX-Lab used a hexa-feeding method with up to 6 hoppers, making it easy to spray multiple powders at once. Powder is transported to the nozzle through the feeder and melted by the laser. Argon gas is used as a shielding gas.

The Inconel 718 powder and the mixed powder were melted and solidified using the directed energy deposition apparatus to form a deposition structure on a base material composed of Inconel 718, respectively. While the directed energy deposition apparatus irradiated a laser beam on the base material, the mixed powder was simultaneously sprayed onto the area where the laser beam was irradiated. The mixed powder was melted on the base material and then solidified again to form a single layer of deposition. By repeating this process to form multiple layers, a nickel-based superalloy directed energy deposition structure was formed on the base material as a result. The deposition structure consisted of equal to or more than five layers. Before forming the deposition structure, 10 powder calibrations were performed to ensure the accuracy of the powder feed rate set on the equipment and the actual powder feed rate.

Hereinafter, the deposition structure formed using the Inconel 718 powder is referred to as an “Inconel deposition structure”. The deposition structure formed using the mixed powder is referred to as an “Inconel-zirconia deposition structure.” In addition, “scan speed” means a laser scan speed.

Table 1 shows common process conditions and common process variables for a deposition structure formed by the method of controlling microstructure of nickel-based superalloy directed energy deposition structure, according to an embodiment of the present invention.

TABLE 1

| Process conditions | Process variables | |
|---|---|---|
| Powder feed rate | 1.6 | g/min |
| Scan strategy | 90° | rotating |
| Laser spot diameter | 400 | μm |
| Hatch spacing | 300 | μm |
| Powder gas flow | 3 | L/min |
| Coaxial gas flow | 8 | L/min |
| Powder Value | 9.28 | |
| Thickness of one layer of deposition structure | 0.15 | mm |
| Number of layers | 5, 8, 10 | |
| Distance between deposition structures | 3 | mm |

In Table 1, the powder value is a numerical value indicating a motor rotation speed for supplying the powder. For example, when the powder value is 100, it means the maximum speed of the motor. The amount of powder discharged changes depending on the motor speed. When the motor rotation speed is fast, the amount of powder discharged increases. The powder feed rate is the amount of powder used per minute. Calibration is performed to convert the powder value into the powder feed rate as a pre-printing setting task. Based on this calibration data, the powder feed rate is approximated and matched. The thickness of one layer of the deposition structure means the thickness of the first layer on the G-code, which is the setting value of the apparatus.

Table 2 shows the laser power, the scan speed, and the laser energy density when performing the method of controlling microstructure of nickel-based superalloy directed energy deposition structure according to an embodiment of the present invention.

TABLE 2

| | Laser power (W) | | | | | | | | |
|---|---|---|---|---|---|---|---|---|---|
| | 150 | 150 | 150 | 250 | 250 | 250 | 350 | 350 | 350 |
| Scan speed | 360 | 600 | 840 | 600 | 1000 | 1400 | 840 | 1400 | 1960 |
| (mm/min) | | | | | | | | | |
| Laser energy | 417 | 250 | 179 | 417 | 250 | 179 | 417 | 250 | 179 |
| Density | | | | | | | | | |
| (J/mm) | | | | | | | | | |

The Inconel deposition structure and the Inconel-zirconia deposition structure were formed to a size of 5 mm×5 mm. When the deposition structures were formed under the same conditions, compared to the Inconel deposition structure, the Inconel-zirconia deposition structure showed over-deposition and electron beam defocusing, thereby causing a height difference among the deposition structures. Therefore, to analyze the height of the deposition structures under the same conditions, Z-axis setting value and the number of layers in the G-code were changed to form deposition structures, as shown in Table 3 below.

Table 3 shows process conditions for a deposition structure formed by a method of controlling microstructure of a nickel-based superalloy directed energy deposition structure, according to an embodiment of the present invention.

TABLE 3

| | | | | |
|---|---|---|---|---|
| Laser power (W) | 250 | 250 | 250 | Other |
| | | | | conditions |
| Scan speed | 600 | 1000 | 1400 | Other |
| (mm/min) | | | | conditions |
| Inconel | 0.09 mm | 0.2 mm | 0.3 mm | 0.15 mm |
| deposition structure | 8 layers | 10 layers | 10 layers | 10 layers |
| Inconel-zirconia | 0.15 mm | 0.15 mm | 0.15 mm | 0.15 mm |
| deposition structure | 5 layers | 5 layers | 5 layers | 5 layers |

The surface defects of the deposition structures were observed at 16× magnification using a stereomicroscope (LEICA EZ4 HD, Leica, Germany). Pores in the deposition structures were observed at 200× magnification using optical microscopy (OM) (LEICA DM ILM+FLEXACAM C1, Leica, Germany). The microstructure of the deposition structures was analyzed using electron backscatter diffraction (EBSD) (AZtecCrystal, Oxford instruments, United Kingdom) at 20 Kv, 100× magnification, and a step size of 2.5 μm. The precipitate analysis in the deposition structures was performed using field emission transmission electron microscopy (FE-TEM) (Talos F200X, Thermo Fisher Scientific, United States). The specimens for the field emission transmission electron microscope were prepared using a focused ion beam (FIB) (SCIOS2, Thermo Fisher Scientific, United States) was used. Hardness measurements were performed using a Vickers hardness tester (HM-122, Mitutoyo, Japan) with a load of 1 kgf. The measurements were performed in five regions, each 200 μm apart, from the interface to the surface. In addition, five measurements were taken at 400 μm intervals from left to right. The hardness was measured a total of five times per condition to ensure the accuracy of the test.

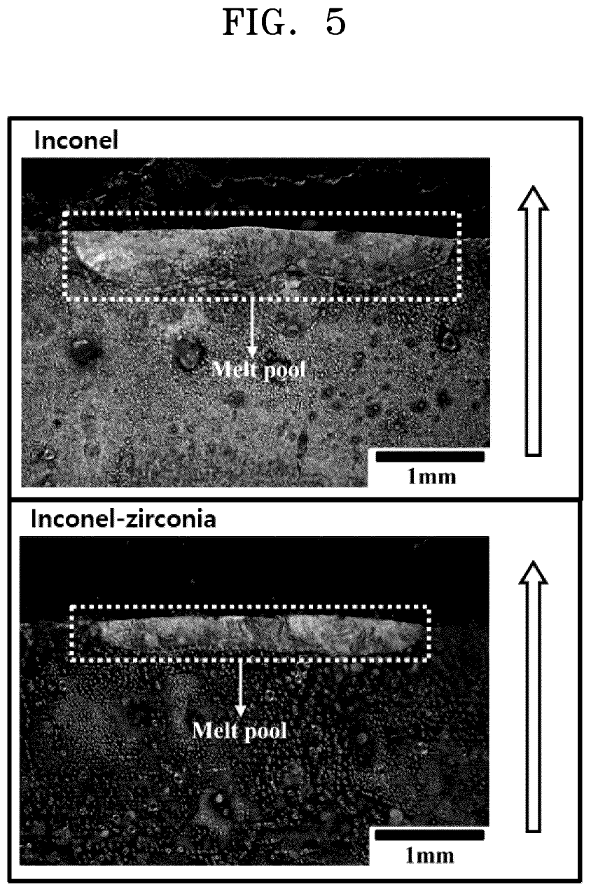

FIG. 5 shows a method of measuring a melt pool volume in a deposition structure formed by a method of controlling microstructure of a nickel-based superalloy directed energy deposition structure, according to an embodiment of the present invention.

Referring to FIG. 5, a melt pool formed in the Inconel deposition structure, and a melt pool formed in the Inconel-zirconia deposition structure. Each arrow indicates the deposition direction of each deposition structure. After measuring the melt pool volume of the melt pool, the process variables may be changed to the internal variables, such as at least one of a volume energy density, a Fourier number, a Marangoni convection value, and a contact ratio, as described below.

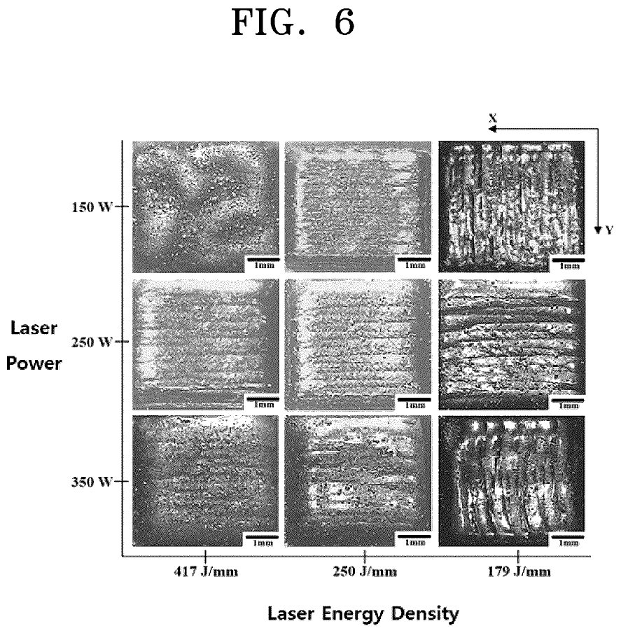

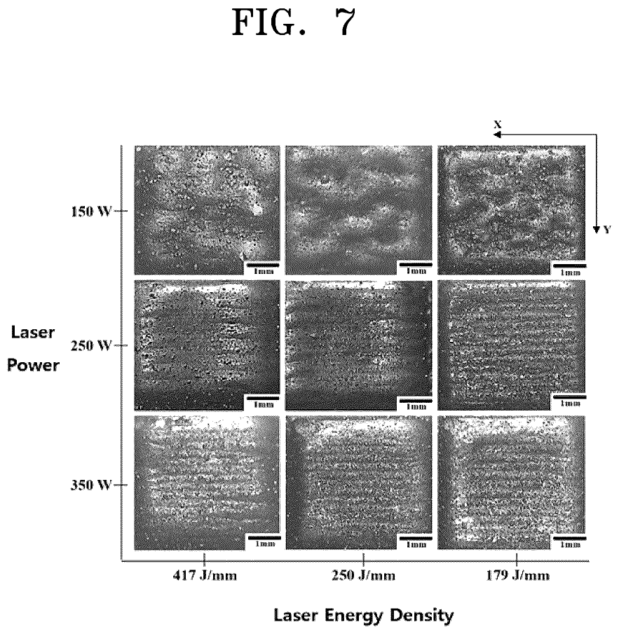

FIGS. 6 and 7 show photographs of surfaces of deposition structures formed by a method of controlling microstructure of a nickel-based superalloy directed energy deposition structure, according to an embodiment of the present invention.

Referring to FIG. 6, photographs of surfaces of the Inconel deposition structures are shown. In the Inconel deposition structure, pores, defects, or sooting were not observed on the surface of the Inconel deposition structure, but balling was observed under all conditions. At the laser power of 150 W and the scan speed of 360 mm/min (i.e., a laser energy density of 417 J/mm), humping was generated, resulting in non-uniform surface. At the laser power of 250 W and the scan speed of 600 mm/min to 1000 mm/min, excellent surface quality was observed. No trends of surface defects were observed in Inconel deposition structure.

Referring to FIG. 7, photographs of surfaces of the Inconel-zirconia deposition structure are shown. In the Inconel-zirconia deposition structure, pores, defects, or sooting were not observed on the surface of the Inconel-zirconia deposition structure, but balling was observed under all conditions. The Inconel-zirconia deposition structures were over-deposited compared to the Inconel deposition structures. The surface quality of the Inconel-zirconia deposition structure improves as the laser power increases. However, at the low laser power of 150 W, humping was generated under all conditions, resulting in non-uniform surface. The surface quality of the Inconel-zirconia deposition structure improves as the scan speed increases. At the laser power of 250 W and the scan speed of 1000 mm/min (i.e., the laser energy density of 250 J/mm), excellent surface quality was observed. For the Inconel-zirconia deposition structure, an improvement in surface quality was observed as both laser power and scan speed increased.

The cause of over-deposition and electron beam defocus phenomenon that cause humping on the surface of the Inconel-zirconia deposition structure may be explained by the following reasons. First, when the amount of the Inconel powder and the amount of the mixed powder loaded into the hopper is not inconsistent. This may lead to over-deposition even when the argon pressure in the hopper for each powder is constant and the powder feed rate is the same, as there is a difference in the amount of the Inconel powder and the mixed powder sprayed from the nozzle. In this case, when the Z-axis setting value of the G-code for the Inconel deposition structure and the Inconel-zirconia deposition structure are the same, electron beam defocusing phenomenon may occur. Second, the zirconia dispersed on the surface of the Inconel 718 powder reduces the friction coefficient between the powders, thereby increasing the powder fluidity, increasing the amount of powder sprayed, and causing the electron beam defocusing phenomenon. Third, the over-deposition and the electron beam defocusing phenomenon may occur depending on hatch spacing setting values and the size of the deposition structure.

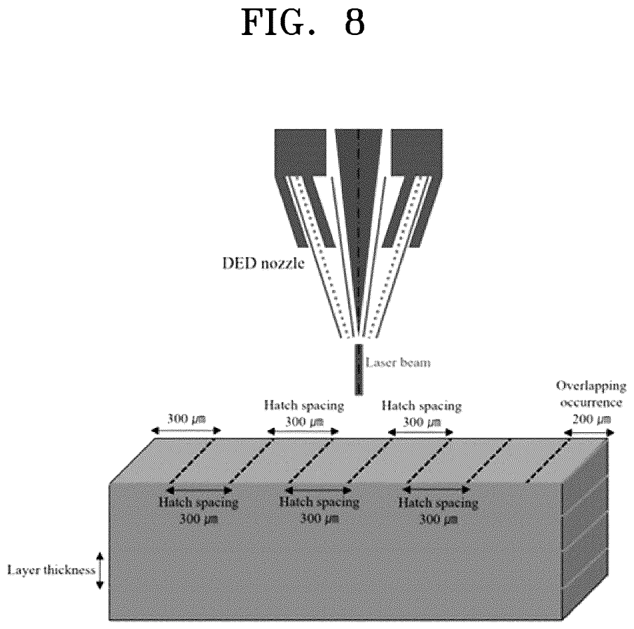

FIG. 8 shows a schematic diagram of hatch distances in a method of controlling microstructure of a nickel-based superalloy directed energy deposition structure, according to an embodiment of the present invention.

Referring to FIG. 8, a laser beam is provided from a nozzle (DED nozzle) of a laser unit to form a deposition structure. The hatch spacing is 300 μm and the size of deposition structure is 5 mm×5 mm. The overlapping occurrence area is about 200 μm. Here, when the size of the deposition structure is 5000 μm, the size divided by the hatch spacing of 300 μm is not divided exactly as an integer in μm, resulting in over-deposition at the corners due to the phenomenon of the laser overlapping and passing through. This may be the cause of the defocusing phenomenon, in which a humping occurs in the center of the deposition structure. Accordingly, as shown in Table 3, the Inconel deposition structure and the Inconel-zirconia deposition structure, in which over-deposition and electron beam defocusing occurred, were formed to the same height within the error range.

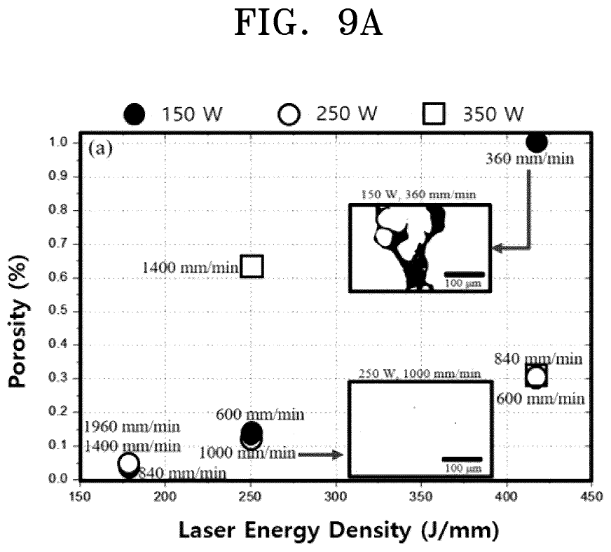

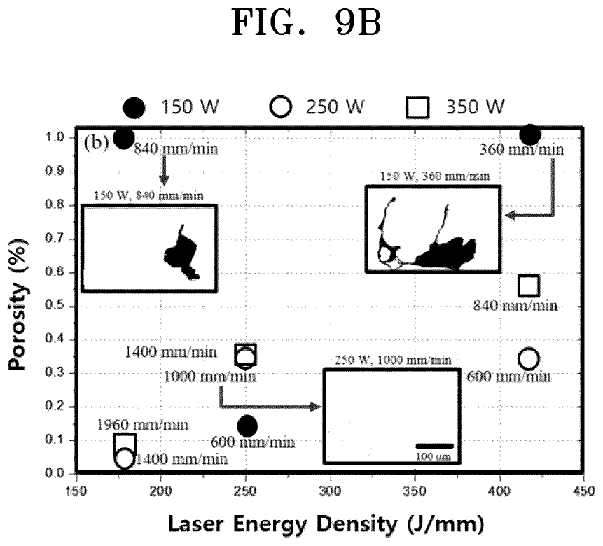

FIGS. 9A and 9B show graphs of average porosity with respect to energy density of a deposition structure formed by a method of controlling microstructure of a nickel-based superalloy directed energy deposition structure, according to an embodiment of the present invention.

Referring to FIGS. 9A and 9B, the average porosity of (a) the Inconel deposition structure and (b) the Inconel-zirconia deposition structure with respect to the laser energy density is shown, as measured using an optical microscope. The average porosity was calculated using OHP film and Image J. The average porosity of the Inconel deposition structure was lower than that of the Inconel-zirconia deposition structure. In general, the average porosity of Inconel deposition structure and the Inconel-zirconia deposition structure is less than 1% at the laser power of 250 W and 350 W. However, lack of fusion occurred in the Inconel deposition structure at the laser power of 150 W and the scan speed of 360 mm/min. The lack of fusion occurred in the Inconel-zirconia deposition structure at the laser power of 150 W and the scan speed s of 360 mm/min and 840 mm/min. When the heat input is low and the humping occurs on the surface, it is analyzed that the probability of the lack of fusion increases.

The average porosity of the Inconel-zirconia deposition structure according to the process variables will be described as follows. Excluding the conditions where lack of fusion occurred, the average porosity of the Inconel-zirconia deposition structure is 0.332% at the laser power of 350 W with generating large amounts of gaseous pores, and the average porosity of the Inconel-zirconia deposition structure is 0.215% at the laser power of 250 W with generating small amounts of gaseous pores. In addition, the average porosity was 0.379% at the scan speed of 600 mm/min with generating large amounts of the gaseous pores. At the scan speed of 1400 mm/min, the average porosity is 0.09%, with generating small amounts of the gaseous pores. This result is analyzed to be due to the surface temperature of the powder is lowered at a fast scan speed, which reduced the evaporation of elements decreased the number of pores in the deposition structure.

Based on the above analysis of porosity, there are some possible reasons for the formation of pores in Inconel-zirconia deposition structure with added zirconia. First, during the melting of zirconia nanoparticles, pores may form caused by evaporating or trapping oxygen. Second, pores may be formed by the gaps between powders. Third, the presence of initial pores in the powders is considered to contribute to the formation of pores in the Inconel-zirconia deposition structures.

According to the described results on the surface defects and average porosity of the deposition structure, an inverse pole figure (IPF) map of the grain microstructure and grain size were analyzed by simplifying the process variables.

Table 4 shows process conditions defined based on the laser power and the scan speed, and the average particle size of a deposition structure formed by a method of controlling microstructure of a nickel-based superalloy directed energy deposition structure, according to an embodiment of the present invention.

TABLE 4

| | | | | Laser | |
|---|---|---|---|---|---|
| | | Laser | Scan | energy | Grain |
| Process | Deposition | power | speed | density | size |
| condition | structure | (W) | (mm/min) | (J/mm) | (μm) |
| A1 | Inconel | 150 | 600 | 2 50 | 61.34 |
| A2 | Inconel | 250 | 600 | 4 17 | 100.06 |
| A3 | Inconel | 250 | 1000 | 2 50 | 115.76 |
| A4 | Inconel | 250 | 1400 | 1 79 | 85.03 |
| A5 | Inconel-Zirconia | 150 | 600 | 2 50 | 88.88 |
| A6 | Inconel-Zirconia | 250 | 600 | 4 17 | 146.39 |
| A7 | Inconel-Zirconia | 250 | 1000 | 2 50 | 71.9 |
| A8 | Inconel-Zirconia | 250 | 1400 | 1 79 | 69.85 |

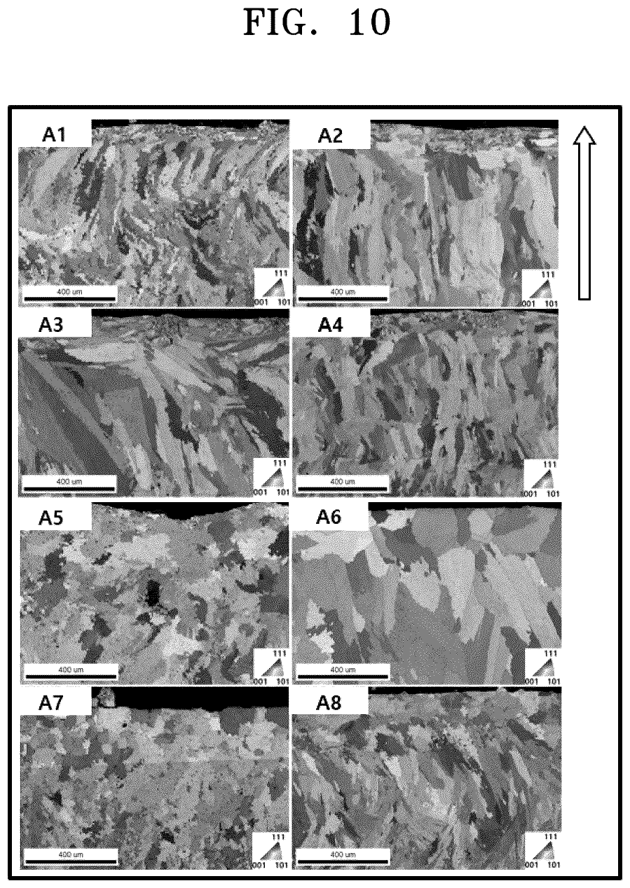

FIG. 10 shows photographs of the microstructure of deposition structures formed by a method of controlling microstructure of a nickel-based superalloy directed energy deposition structure, according to an embodiment of the present invention.

Referring to FIGS. 10, A1, A2, A3, and A4 show inverse pole figure maps for the Inconel deposition structure, A5, A6, A7, and A8 show inverse pole figure maps for the Inconel-zirconia deposition structure. The deposition directions of the structures are indicated by the arrow.

Referring to FIG. 10 and Table 4, columnar grains are formed in the Inconel deposition structure under all conditions. Fine grains are formed at the surface, but coarse grains are formed at the interior under all conditions. As a result of the microstructural analysis of the Inconel deposition structure, it is analyzed that the non-uniformity of the deposition structure is due to the solidification rate and temperature gradient depending on the deposition region. In conclusion, it is analyzed that the Inconel deposition structure will have anisotropy in mechanical properties due to the non-uniformity of the deposition structure.

For the Inconel-zirconia deposition structure, microstructural changes were observed under the A6 condition, that is, the laser power of 250 W. and the scan speed of 600 mm/min, and the laser energy density of 417 J/mm, but coarse columnar grains with an average grain size of 146.39 um were formed. Under the A8 condition, that is, the laser power of 250 W, the scan speed of 1400 mm/min, and the laser energy density of 179 J/mm, columnar grains were formed without any change in microstructure, like the Inconel deposition structure. Under the A5 condition, that is, the laser power of 150 W and the scan speed of 600 mm/min, and the laser energy density of 250 J/mm, the average grain size is 88.8 μm and a transition from columnar grains to equiaxed grains was observed. However, the equiaxed grains were rarely formed, and the coarse columnar grains were numerously formed. Under the A7 condition, that is, the laser power of 250 W and the scan speed of 1000 mm/min, the laser energy density of 250 J/mm, fine equiaxed grains with an average grain size of 71.9 μm were numerously formed, and the columnar grains were rarely formed.

According to the grain analysis results, the optimal condition is the A7 condition. Under the A7 condition, compared to the A1, A2, A3, and A4 conditions, the aspect ratio of the columnar grains was smaller than those of the A1, A2, A3, and A4 conditions and a uniform microstructure was observed. Based on these results, it is analyzed that the Inconel-zirconia deposition structure may have less anisotropy in mechanical properties, the zirconia nanoparticles act as an inoculant to induce the grain refinement and the formation of equiaxed grains.

Hereinafter, to derive and interpret effects of the grain refinement and the formation of equiaxed grains of the Inconel-zirconia deposition structure, process variables and internal variables were applied and analyzed.

The process variables include the laser power, the scan speed, and the laser energy density used in the deposition process of the deposition structure.

The laser energy density may satisfy the following equation 5.

$$[ Laser energy density ] = [ Laser power ] / ( [ scan speed ] \times [ hatching spacing ] \times [ thickness of one layer of a deposition structure ] ) \qquad [ Equation 5 ]$$

Here, the hatch spacing and the thickness of one layer of a deposition structure is same for all conditions, and then the laser energy density may be obtained by dividing the laser power by the scan speed.

The internal variables may include at least one of a volume energy density, a Fourier number, a Marangoni convection value, and a contact ratio. For example, the internal variables may include the volume energy density, the Marangoni convection value, and the contact ratio. For example, the internal variables may include the volume energy density, the Marangoni convection value, and the Fourier number.

The volume energy density is the value of the obtained by dividing the laser energy density by the volume of the melt pool formed by laser irradiation, as shown in Equation 1 below. As the volume energy density increases, the laser energy density per unit area of the melt pool increases, thereby increasing the melting of zirconia.

$$[ volume energy density ] = [ laser energy density ] / [ volume of melt pool ] \qquad [ Equation 1 ]$$

The contact ratio is the value obtained by dividing the cross-sectional area of the melt pool in contact with the substrate or parent material by the cross-sectional area of the entire melt pool, as shown in Equation 2 below. The cross-sectional area may be the maximum cross-sectional area.

$$[ contact ratio ] = [ area of melt pool contacting parent material ] / [ total area of melt pool ] \qquad [ Equation 2 ]$$

As the contact ratio increases, heat dissipation increases, the cooling rate increases, and G/R (thermal gradient/solidification rate) decreases. Here, the solidification rate behaves dominantly, thereby increasing the solidification rate.

The Marangoni convection value may satisfy the following Equation 3:

$$[ Marangoni convection ] = ( dT / d γ ) \times ( w Δ T / μα ) \qquad [ Equation 3 ]$$

Here, T is temperature of a melt pool, γ is surface tension, w is a width of the melt pool, ΔT is difference between maximum temperature and solidus temperature of the melt pool, μ is viscosity of the melt pool, and α is thermal diffusivity of the melt pool.

As the Marangoni convection value increases, the melting of zirconia increases, the nucleation behavior increases, and the solidification rate (R) increases. The surface tension and ΔT value of the Marangoni convection may be derived in future experiments or calculated from the measurement of viscosity, thermal diffusivity, and width of the melt pool. In conclusion, as the internal variables such as the volume energy density, the contact ratio, and the Marangoni convection value increases, the grain refinement and the formation of equiaxed grains may be induced.

The Fourier number is a dimensionless number that represents a time scale during heat dissipation process and is used as a measure to compare the heat dissipation rate and heat storage rate of a material.

The Fourier number may satisfy the following equation 4:

$$[ Fourier number ] = α / ( V \times L ) \qquad [ Equation 4 ]$$

Here, α is thermal diffusivity of a melt pool, V is a scan speed, and L is a length of the melt pool.

Table 5 shows numerical values of internal variables for deposition structures formed by a method of controlling microstructure of a nickel-based superalloy directed energy deposition structure, according to an embodiment of the present invention.

TABLE 5

| | Deposition structure | | | | |
|---|---|---|---|---|---|
| | Inconel | Inconel-Zirconia | | | |
| Laser Power (W) | 250 | 250 | 150 | 250 | 250 |
| Scan speed (mm/min) | 1000 | 600 | 600 | 1000 | 250 |
| volume energy density | 0.022 | 0.0337 | 0.0373 | 0.0506 | 0.0214 |
| Marangoni convection | 3.644 | 2.223 | 3.246 | 3.475 | 3.734 |
| value | | | | | |
| Contact ratio | 0.98 | 0.72 | 0.79 | 0.93 | 0.98 |
| Fourier number | 0.00773 | 0.002645 | 0.01893 | 0.01052 | 0.008025 |

The microstructures analyzed for the grain refinement and the formation of equiaxed grains according to process variables and internal variables were classified as follows. (1) A3 condition (columnar grains, Inconel 718 deposition structure, comparative example), (2) A5 condition (equiaxed grains+columnar grains), (3) A6 condition (columnar, coarse grains), (4) A7 condition (equiaxed, fine grains), (5) A8 condition (columnar grains, similar grains to A3). The A3 and A5, A6, A7, and A8 conditions were presented in two-dimensional and three-dimensional graphs to analyze the grain refinement and the formation of equiaxed grains according to process variables and internal variables.

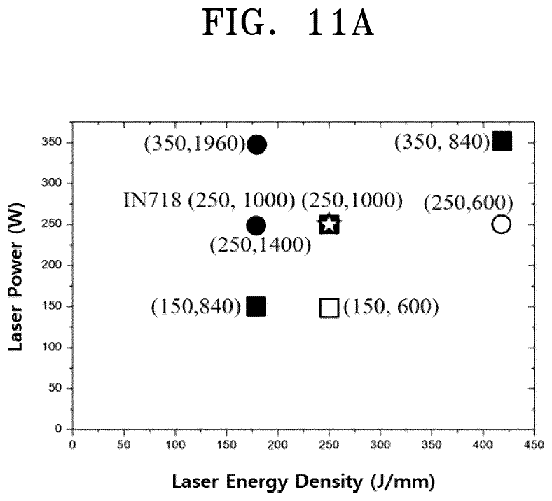

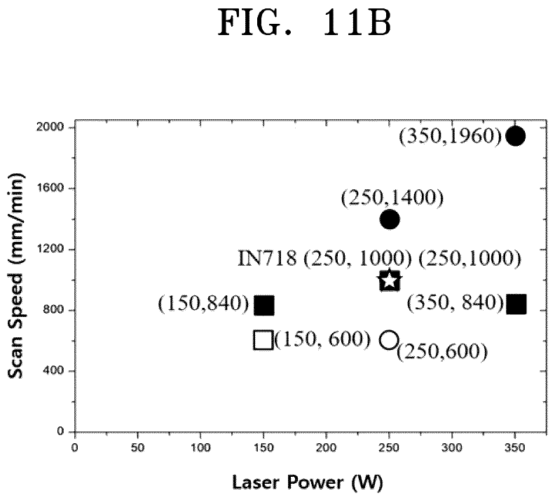

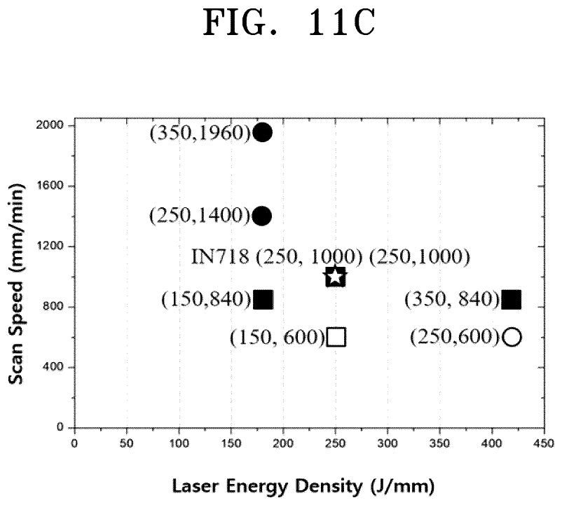

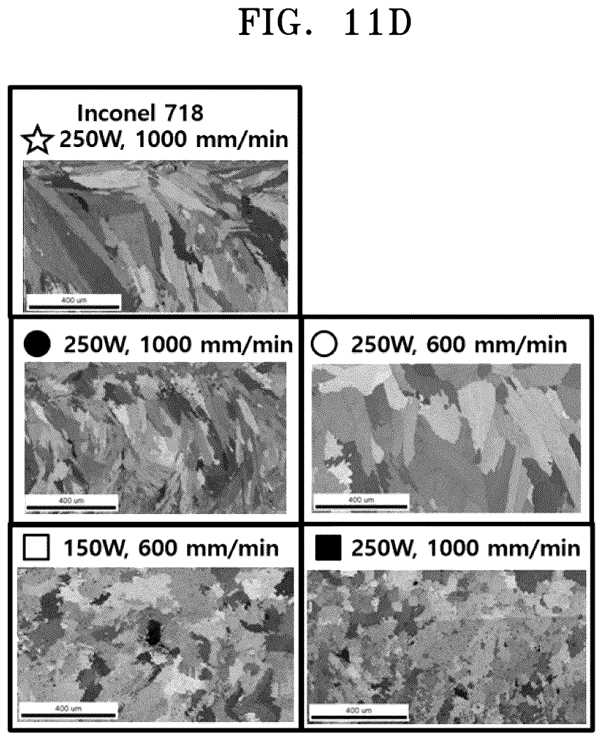

FIGS. 11A to 14 show information for deriving correlations for the microstructures of deposition structures formed by a method of controlling microstructure of a nickel-based superalloy directed energy deposition structure, according to an embodiment of the present invention.

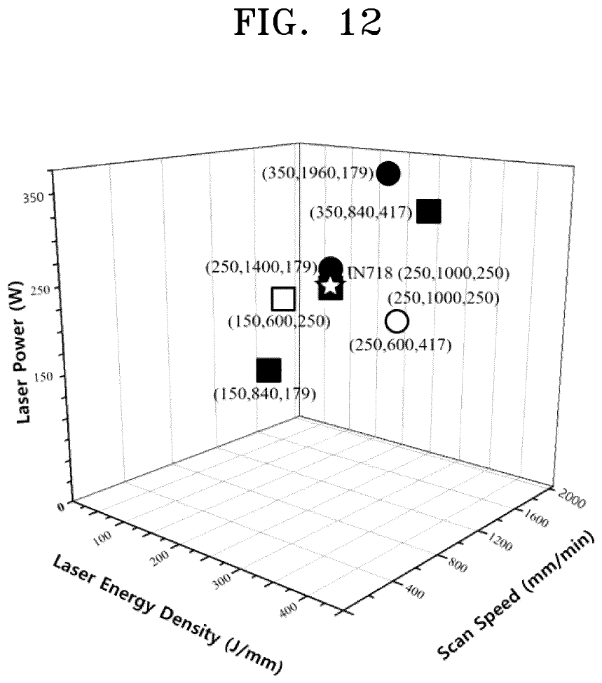

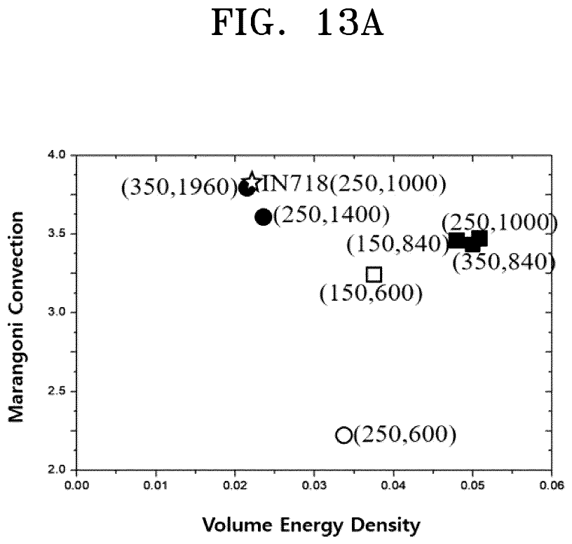

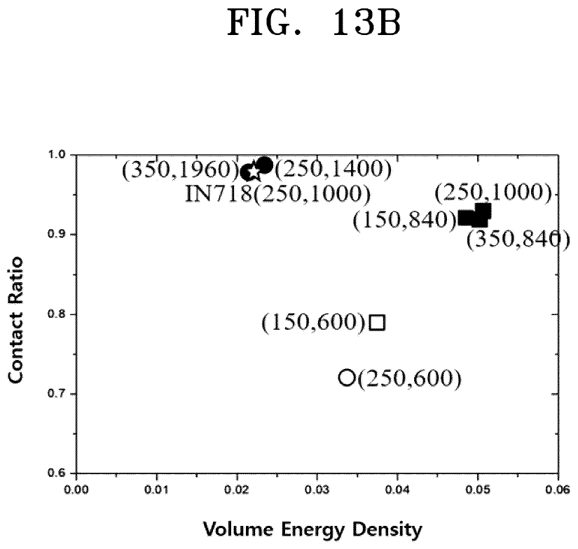

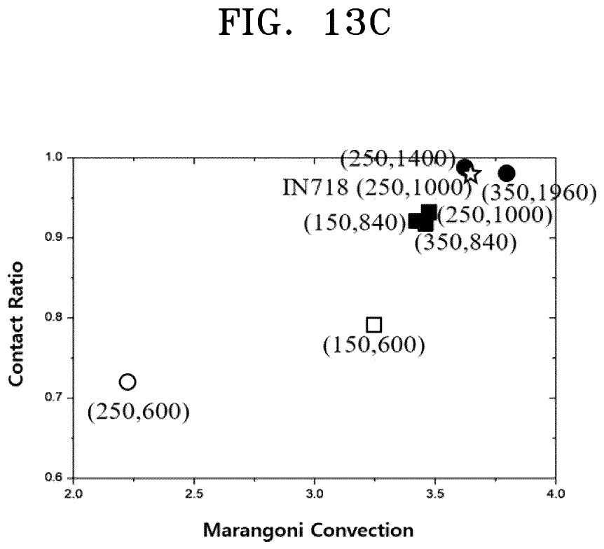

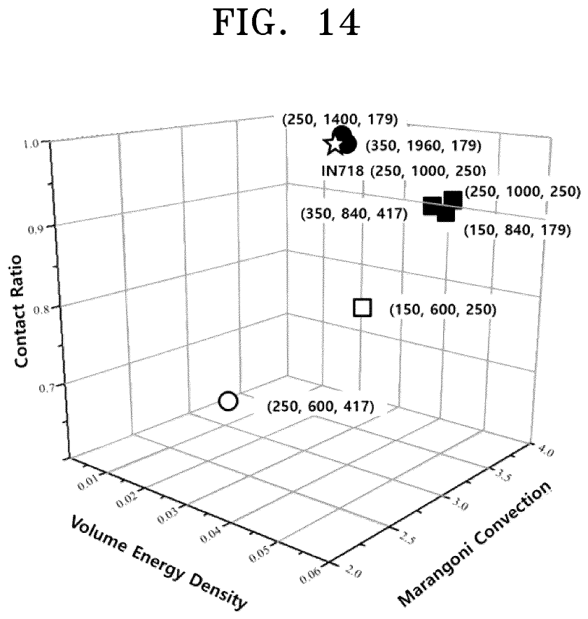

In FIGS. 11A, 11B, 11C, 13A, 13B, and 13C, each data shows “(laser power, scan speed)”. In FIGS. 12 and 14, each data shows “(laser power, scan speed, laser density).

Referring to FIGS. 11A, 11B, and 11C, two-dimensional graphs for analyzing the grain refinement and the formation of equiaxed grains with respect to process variables are shown. Referring to FIG. 11A, the graph shows data with respect to process variables, such as the laser power versus the laser energy density. Referring to FIG. 11B, the graph shows data with respect to process variables, such as the scan speed versus the laser power. Referring to FIG. 11C, the graph shows data with respect to process variables, such as the scan speed versus the laser energy density.

Referring to FIG. 11D, for the Inconel 718 deposition structure, in the case of 250 W and 1000 mm/min, columnar grains were formed, and the average grain size was 115.76 μm. However, for the Inconel-zirconia deposition structure, in the case of 250 W and 1000 mm/min, columnar grains were formed without any change in microstructure, and the average grain size was 86.3 μm. In the case of 250 W and 600 mm/min, coarse and columnar grains were formed, and the average grain size was 146.39 μm. In the case of 150 W and 600 mm/min, the grains were changed, equiaxed grains and columnar grains were formed, and the average grain size was 88.8 μm. In the case of 250 W and 1000 mm/min, fine and equiaxed grains and columnar grains were formed, the average grain size was 71.9 μm.

Referring to FIG. 12, a three-dimensional graph for the laser energy density, the scan speed, and laser power by integrating the two-dimensional graphs in FIGS. 11A to 11C is shown. In the graph, since data points are scattered regardless of the types of the grains, no tendency was found. Therefore, it is analyzed that any microstructure development factors may not be derived from this three-dimensional graph constructed by the process variables. In other words, any correlation between the microstructures of the deposition structures and the process variables may not be established.

Referring to FIG. 13A, 13B, and 13C, two-dimensional graphs for analyzing the grain refinement and the formation of equiaxed grains with respect to the internal variables are shown. Referring to FIG. 13A, the graph shows data with respect to the internal variables, such as the Marangoni convection value versus the volume energy density. Referring to FIG. 13B, the graph shows data with respect to the internal variables, such as the contact ratio versus the volume energy density. Referring to FIG. 13C, the graph shows data with respect to the internal variables, such as the contact ratio versus the Marangoni convection value. The microstructures are shown in FIG. 11D.

Referring to FIG. 14, a three-dimensional graph for the volume energy density, the Marangoni convection value, and the contact ratio by integrating the two-dimensional graphs in

FIGS. 13A to 13C is shown. In this graph, since data points are gathered according to the types of the grains, tendency is observed. That is, the data points of the deposition structures of IN718 (250, 1000, 250), (350, 1960, 179), and (250, 1400, 179) having columnar grains are gathered. The data points of the deposition structures of (150, 840, 179), (250, 1000, 250), and (350, 840, 417) having fine equiaxed grains are gathered. The data point of the deposition structure of (150, 600, 250), having a mixed structure of columnar grains and equiaxed grains, is displaced separately and individually. The data point of the deposition structures of (250, 600, 417) having coarse columnar grains is displaced separately and individually.

Here, the data point having “IN718” corresponds to the Inconel 718 deposition structure and the data points without “IN718” correspond to the Inconel-zirconia deposition structure.

Therefore, it is analyzed that the microstructure development factors are derived from the three-dimensional graph constructed with the internal variables. That is, correlations between the microstructures of the deposition structures and the internal variables are derived.

Since the A8 condition (250 W, 1400 mm/min) under which columnar grains are formed, like the A3 condition (250 W, 1000 mm/min), has a volume energy density (VED) of 0.0214, which is lower than those of other conditions, zirconia nanoparticles were not melted. This is significantly different from the volume energy density of 0.0506 in the A7 condition (250 W, 1000 mm/min) under which fine equiaxed grains are formed under the same laser power condition. The A8 condition has an insignificant inoculation effect of zirconia nanoparticles due to the low volume energy density. There was no transition from columnar grains to equiaxed grains.

In the A7 condition (250 W, 1000 mm/min) under which fine equiaxed grains are formed, the contact ratio is 0.96 and the Marangoni convection value is 3.475. The Marangoni convection value is the highest among the classified conditions. As the contact ratio increases, G×R (thermal gradient×solidification rate) increases, G/R (thermal gradient/solidification rate) decreases. Here, when the particle size and the added amount of zirconia are the same, thermal gradient (G) is almost the same. Therefore, the effect of the solidification rate (R) becomes dominant. As the solidification rate (R) increases, nucleation behavior increases, thereby inducing the grain refinement and the formation of equiaxed grains.

In addition, the Marangoni convection value increases, thereby inducing the grain refinement and the formation of equiaxed grains. When the Marangoni convection value increases, a large amount of zirconia is melted in the molten metal, and the transport of nucleation sites and nucleation behavior increase, thereby increasing the solidification rate (R). Therefore, when the contact ratio and the Marangoni convection value increase, the solidification rate increases, thereby inducing the grain refinement and the formation of equiaxed grains.

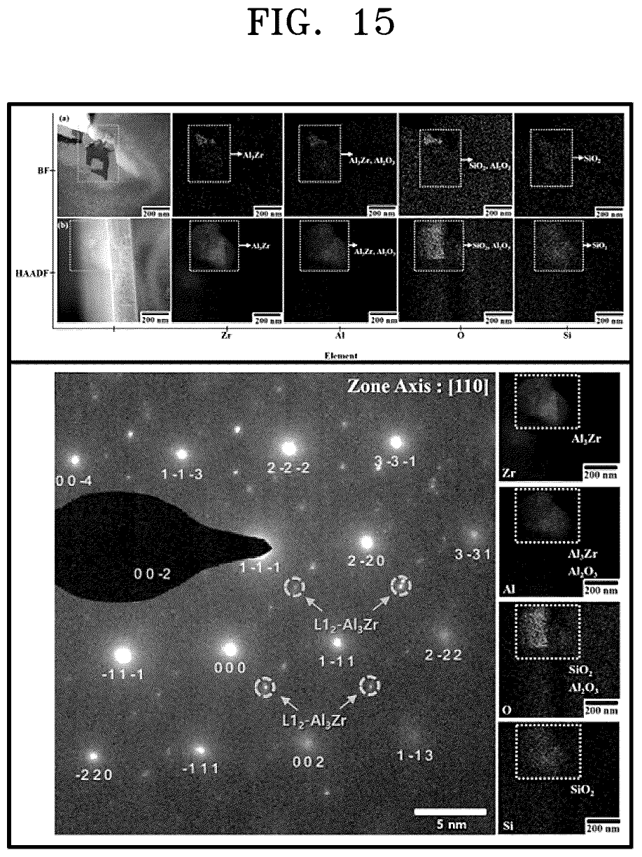

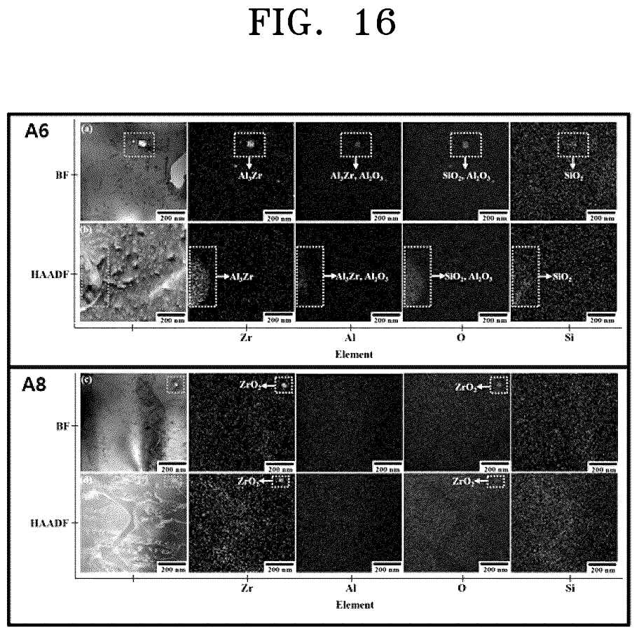

FIGS. 15 and 16 show results of analyzing precipitates in deposition structures formed by a method of controlling microstructure of a nickel-based superalloy directed energy deposition structure, according to an embodiment of the present invention.

Referring to FIG. 15, this is the result of analyzing precipitates in the Inconel-zirconia deposition structure formed under the A7 condition (250 W, 1000 mm/min) using FE-TEM (field emission transmission electron microscope). Under the A7 condition, fine equiaxed grains were formed in the Inconel-zirconia deposition structure, and a large amount of zirconia is melted due to the high volume energy density regardless of regions. Therefore, the Al₃Zr intermetallic compounds and oxides, for example, SiO₂ and Al₂O₃, were numerously formed. In addition, it is analyzed that fine grains were formed due to the high contact ratio, the Marangoni convection value, and the cooling rate, and equiaxed grains were formed due to the high solidification rate (R). The numerously formed Al₃Zr intermetallic compound caused the heterogeneous nucleation and the grain boundary pinning effect, leading to the grain refinement and the formation of equiaxed grains. In the diffraction pattern, peaks corresponding to the Al₃Zr intermetallic compounds of metastable L1₂ structure were observed. The peaks were unclear and faint, because the aluminum content in Inconel 718 is very low (Al=0.52%), so the amount of the Al₃Zr intermetallic compound is small. Observation of double peaks is shown because oxides such as SiO₂ and Al₂O₃ were formed together with the Al₃Zr intermetallic compounds.

Referring to FIG. 16, this is the result of analyzing precipitates in the Inconel-zirconia deposition structure formed under the A6 condition and the A8 condition using FE-TEM (field emission transmission electron microscope).

Referring to FIG. 16, under the A6 condition (250 W, 600 mm/min), coarse columnar grains were formed in the Inconel-zirconia deposition structure, and zirconia is rarely melted due to the low volumetric energy density compared to the A7 condition where fine equiaxed grains are formed. Accordingly, the Al₃Zr intermetallic compound and oxides such as SiO₂ and Al₂O₃ were formed only in specific regions. In addition, the contact ratio, the Marangoni convection value, and the cooling rate were lower than those under the A7 condition, resulting in forming coarse grains, and solidification rate (R) value was lower, resulting in forming columnar grains. Since the

Al₃Zr intermetallic compounds are formed only in specific regions, the heterogeneous nucleation and the grain boundary pinning effect are insignificant, and the grain refinement and the formation of equiaxed grains are insignificant.

Under the A8 condition (250 W, 1400 mm/min), like the A3 condition showing columnar grains, unmolten zirconia was observed regardless of regions. In the A8 condition, zirconia remained unmolten due to the low volume energy density. As a result, the Al₃Zr intermetallic compounds were not formed, the heterogeneous nucleation and the grain boundary pinning effect did not occur, and columnar grains were formed without any change in microstructure. However, it is analyzed that fine equiaxed grains were formed due to the high contact ratio, the Marangoni convection value, and the cooling rate.

The conditions for the grain refinement and the formation of equiaxed grains caused by Al₃Zr intermetallic compound are as follows. First, zirconia must be melted by the high volumetric energy density. The molten zirconia is reduced to Zr and O₂, thereby forming Al₃Zr intermetallic compounds and oxide such as SiO₂ and Al₂O₃. The formation of Al₃Zr intermetallic compound induces the heterogeneous nucleation and the grain boundary pinning effect. Here, when ZrO₂ is not melted due to the low volumetric energy density, Al₃Zr intermetallic compound is not formed, and then the heterogeneous nucleation effect and the grain boundary pinning effect do not occur. Second, high Marangoni convection and high contact ratio are required. This is caused by the melting of zirconia, like the volume energy density. In addition, heat dissipation and cooling rate increase, and the solidification rate (R) increase, thereby inducing the grain refinement and the formation of equiaxed grains.

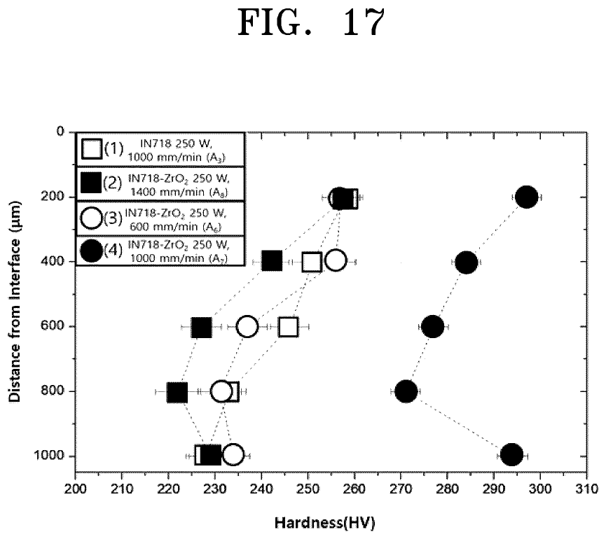

FIG. 17 shows a graph of hardness of deposition structures formed by a method of controlling microstructure of a nickel-based superalloy directed energy deposition structure, according to an embodiment of the present invention.

Referring to FIG. 17, Vickers hardnesses of the Inconel deposition structure under the A3 condition (250 W, 1000 mm/min) and the Inconel-zirconia deposition structures under the A6 condition (250 W, 600 mm/min), A7 condition (250 W, 1000 mm/min) and A8 condition (250 W, 1400 mm/min) are shown. The average hardnesses for the A3 condition, the A6 condition, and the A8 condition having columnar grains respectively are 236 Hv, 243 Hv, and 235 Hv, respectively. The average hardness for the A7 condition having equiaxed grains is 285 Hv, thereby increasing the hardness. Compared with the A3 condition, the A6 condition, and the A8 condition, the average hardnesses for the A7 condition have greater in the range of 38 Hv to 45 Hv from the interface to just below the surface and greater in the range of 60 Hv to 66 Hv on the surface. It is analyzed that the hardness increase is caused by the grain refinement and the formation of equiaxed grains due to the Al₃Zr intermetallic compounds formed under the A7 condition and the dispersed oxides such as Al₂O₃ and SiO₂.

Hereinafter, the derivation and interpretation of microstructure development factors by addition of zirconia nano-powder will be explained.

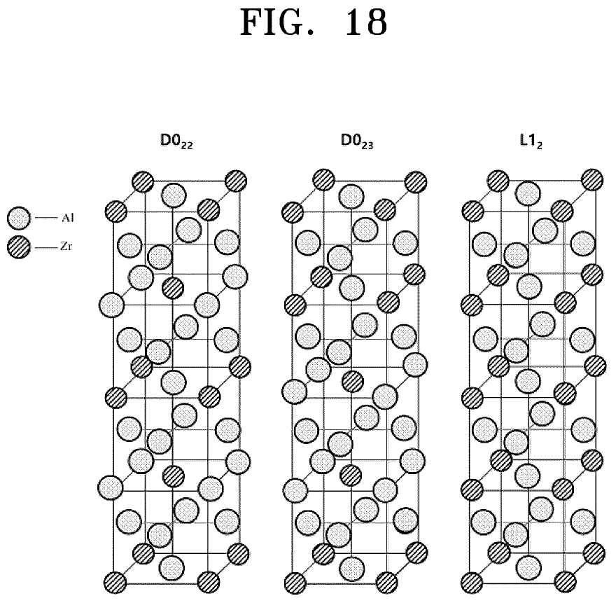

FIGS. 18 to 24 show information for explaining microstructure development factors for a deposition structure formed by a method of controlling microstructure of a nickel-based superalloy directed energy deposition structure, according to an embodiment of the present invention.

For the Inconel-zirconia deposition structure formed by adding zirconia to the Inconel 718 powder, zirconia nanoparticles act as an inoculation, thereby inducing the grain refinement and the formation of equiaxed grains. The reason for the inoculation of a nucleating agent is that there is not enough time for the limited convection to transport the nucleation sites under rapid solidification conditions. The following are the factors that express the grain refinement and the formation of equiaxed grains by the inoculant of zirconia nanoparticles as a nucleating agent.

The first factor is the high lattice matching of solidified intermetallic compounds. The inoculant must not only act as a carrier of nucleation sites, but also have a low melting point, be solidified after melting, and form a proeutectic phase. In addition, the formed proeutectic phase and the interface must form a coherent interface. Zirconia nanoparticles satisfy above all conditions, and the precipitated Al₃Zr intermetallic compound has a metastable L1₂ structure. The metastable L1₂ structure of the Al₃Zr intermetallic compound has excellent lattice matching (cube orientation relationship), which is attributed to the heterogeneous nucleation. Therefore, zirconia nanoparticles acted as an effective inoculant. See table 6 and FIG. 18 below.

Table 6 shows lattice constants of intermetallic compounds formed in a deposition structure formed by a method of controlling microstructure of a nickel-based superalloy directed energy deposition structure, according to an embodiment of the present invention.

TABLE 6

| Intermetallic compound | Crystal structure | Lattice constant (Å) |
|---|---|---|
| Al | Cubic | a = 4.0562 |
| Al₃Ti (equilibrium phase) | D0₂₂ | a = 3.849, c = 8.610 |
| Al₃Zr (equilibrium phase) | D0₂₃ | a = 4.013, c = 17.321 |
| Al₃Ti (metastable phase) | L1₂ | a = 3.967 |
| Al₃Zr (metastable phase) | L1₂ | a = 4.090 |

Referring to FIG. 18, crystal structures of D0₂₂, D0₂₃, and L1₂ of Al₃Zr intermetallic compound formed in the Inconel-zirconia deposition structure are shown.

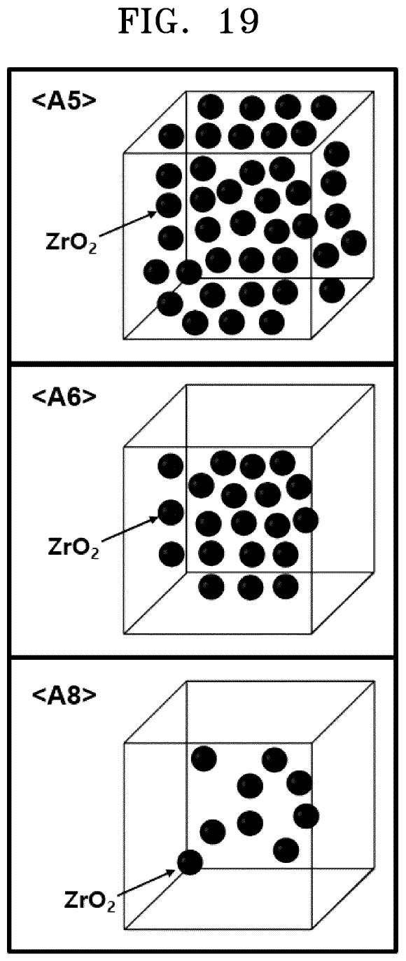

The second factor is the volumetric energy density. Despite the addition of zirconia nanoparticles, the volumetric energy density of the A8 condition was low, so the zirconia nanoparticles did not melt and Al₃Zr intermetallic compound was not formed. Therefore, the heterogeneous nucleation or the grain boundary pinning effect did not occurred, and columnar grains were formed without any change in the shape, like the Inconel 718 deposition structure. On the other hand, under the A7 condition, the zirconia nanoparticles numerously melted due to the high volumetric energy density, thereby numerously forming the Al₃Zr intermetallic compounds. The formation of the Al₃Zr intermetallic compounds caused the heterogeneous nucleation and the grain boundary pinning effect, which led to the grain refinement and the formation of equiaxed grains. See FIG. 19 below.

Referring to FIG. 19, the relationship between the volume energy density and the amount of molten zirconia nano-powder is shown. For the A5 condition, the volume energy density is 0.0506 and high. For the A6 condition, the volume energy density is 0.0337 and intermediate. For the A8 condition, the volume energy density is 0.0214 and low.

The third factor is the Marangoni convection. During the directed energy deposition process, molten zirconia nanoparticles with a relatively low density compared to the Inconel 718 are dissolved into melt pool by Marangoni convection, thereby supplying zirconium (Zr). As the Marangoni convection increases, more zirconia nanoparticles melt, nucleation behavior increases, and solidification rate increases to lead to the grain refinement and the formation of equiaxed grains. In addition, as the Marangoni convection increases, more numerous secondary and tertiary dendritic branches cut, which act as nucleation sites and solid nuclei. After cutting, the secondary and tertiary dendritic branches act as nucleation sites to lead to formation of equiaxed grains. The microstructural changes caused by the difference in Marangoni convection may be observed.

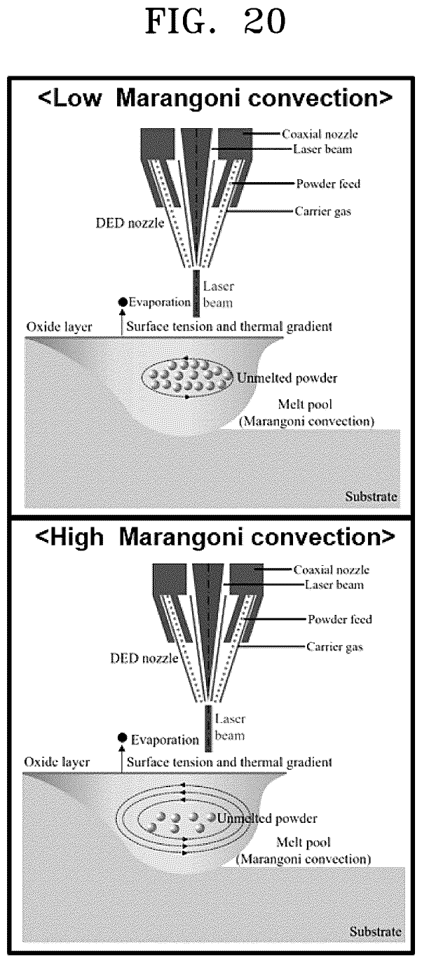

Referring to FIG. 20, schematic diagrams of Marangoni convection are shown respectively for low and high Marangoni convection values.

Under the A6 condition, the Marangoni convection value is 2.2 and relatively low, and coarse columnar grains with an average grain size of 146.39 μm were formed. Since the Marangoni convection value is low, it is not enough to transport nucleation sites, and little zirconia (ZrO₂) nanoparticles melted. In addition, it is analyzed that the grain refinement and the formation of equiaxed grains did not occur because the secondary and tertiary dendritic branches did not occur cutting.

On the other hand, under the A7 condition, the Marangoni convection value is 3.5 and relatively high, and fine equiaxed grains with an average grain size of 71.9 μm were formed. Since the Marangoni convection value is high, it is sufficient to transport nucleation sites, and numerous zirconia nanoparticles melted. In addition, it is analyzed that the grain refinement and the formation of equiaxed grains were maximized because the numerous secondary and tertiary dendritic branches occurred cutting.

The fourth factor is the contact ratio. In the high contact ratio, heat dissipation and cooling rate increase, and G/R (thermal gradient/solidification rate) decreases. Like the Marangoni convection, the solidification rate (R) behaves dominantly. It is analyzed that the solidification rate (R) increases, resulting in the grain refinement and the formation of equiaxed grains.

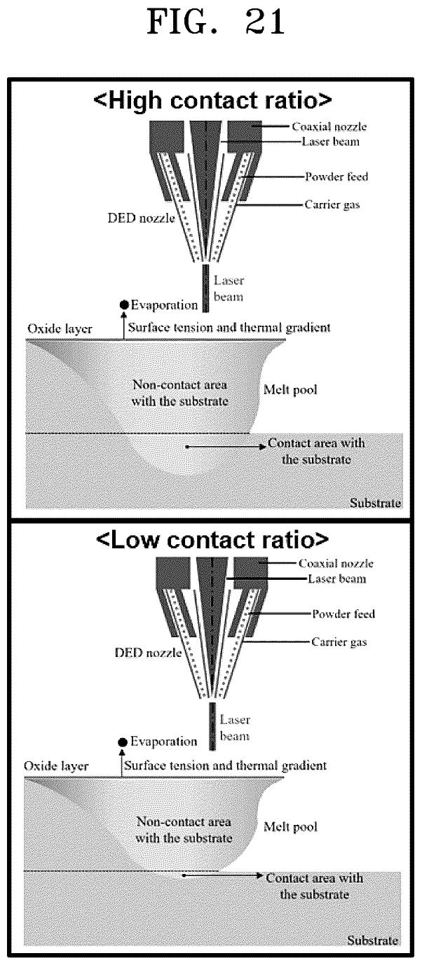

Referring to FIG. 21, schematic diagrams of contact ratios of the contact area between melt pool and parent material are shown respectively for low and high contact ratios.

For the A5 condition, the Marangoni convection value is 3.2 and a transition from columnar grains to equiaxed grains occurs. For the A7 condition, the Marangoni convection value is 3.5 and fine equiaxed grains are formed. For the A5 condition and the A7 condition, the Marangoni convection values are similar. However, since the contact ratio of the A5 condition is 0.73 and the contact ratio of the A7 condition is 0.93, the contact ratio of the A5 condition is relatively lower than that of the A7 condition. The lower contact ratio of the A5 condition results in slower heat dissipation and cooling rate and a higher G/R value, compared with the A7 condition. Therefore, it is analyzed that the equiaxed grains were rarely formed under the A5 condition due to the lower R value. However, the grain refinement and the formation of equiaxed grains due to solidification rate cannot be compared between Inconel 718 and Inconel 718-zirconia deposition structures, and only Inconel 718-zirconia deposition structures can be compared.

Hereinafter, the grain refinement and the formation of equiaxed grains by adding zirconia nano-powder will be described.

The grain refinement effects may be caused by the grain boundary pinning. The formation of equiaxed grains may be caused by the heterogeneous nucleation, the Marangoni convection, and the Fourier number.

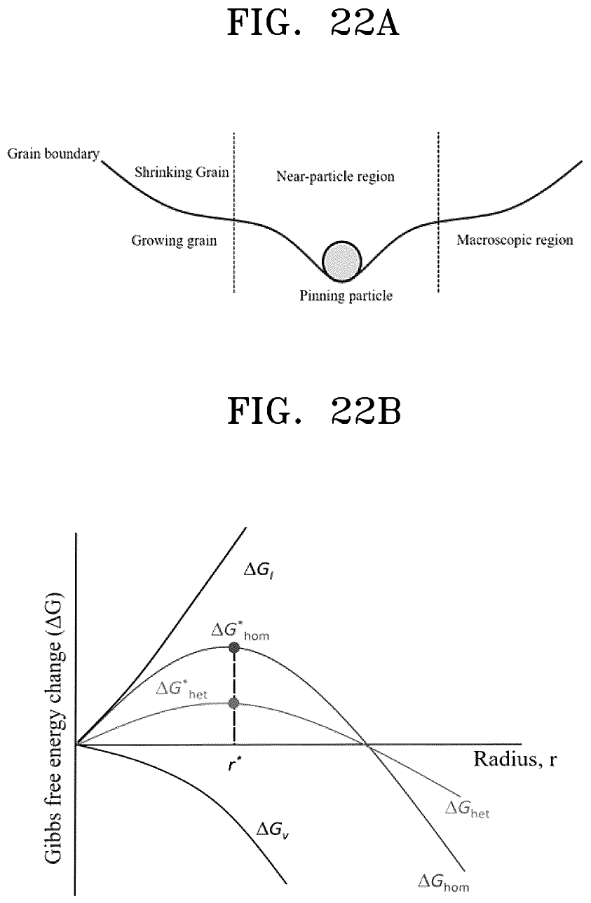

Referring to FIGS. 22A and 22B, the effects of grain boundary pinning and the heterogeneous nucleation on the grain refinement and equiaxed grains microstructure formation are shown. Referring to FIG. 22A, is a schematic diagram of grain boundary pinning, Referring to FIGS. 22B, and (b) is a graph showing the effect of the heterogeneous nucleation.

Referring to FIG. 22A, a particle pinning theory according to Zener's theory, which is the effect of contact between particles on grain growth, is shown. When a pinning particle contacts a grain boundary, grain growth is delayed. The interfacial energy is balanced at the contact point among the pinning particle, a growing grain, and a shrinking grain. In addition, when a secondary phase particle meets a moving grain boundary, a new interface is formed to replace an original interface. Since relatively large grains generally have a small driving force for grain boundary movement due to grain boundary curvature, the shape of a curved grain boundary around the particle may generate sufficient fixing force to suppress the grain boundary movement. On the other hand, when a particle has relatively small size, a grain boundary bending around the particle receives greater driving force as the grain boundary curvature increases. Therefore, the movement of the grain boundary cannot be completely suppressed. That is, the particle fixing effect varies depending on the particle size and the grain size, and the particle fixing effect is more significant when the particle and the grain have greater size.

Referring to FIG. 22B, Gibbs free energy change as a function of cluster size is shown. The Gibbs free energy change represents formation of a nucleus by overcoming energy barriers in homogeneous nucleation process or heterogeneous nucleation process. The Gibbs free energy change depends on the changes in interfacial energy and volume free energy. The energy barrier for the heterogeneous nucleation process with the same critical radius is only a portion of the energy barrier for the homogeneous nucleation process. The heterogeneous nucleation process, related to ΔG*ₕₑₜ, may occur at a lower energy barrier than the homogeneous nucleation process, related to ΔG*ₕₒₘ.

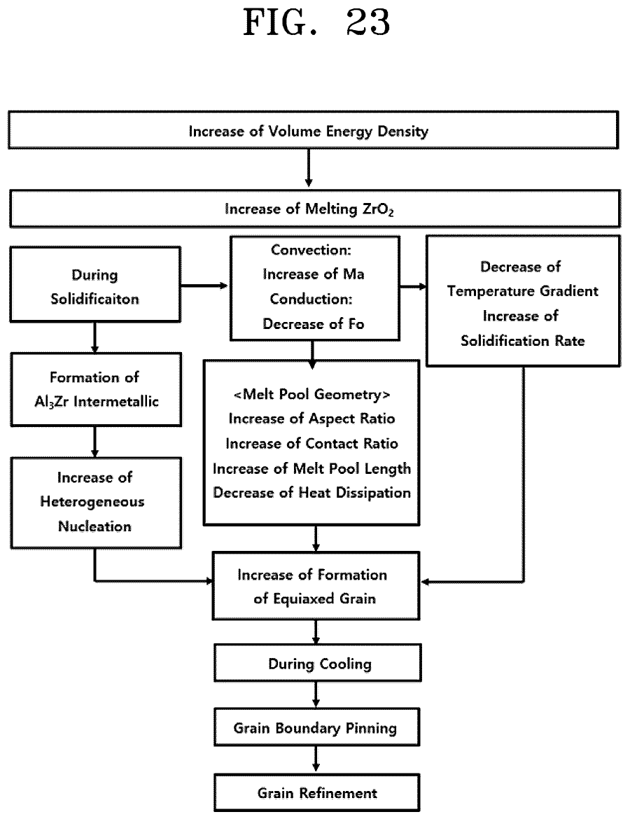

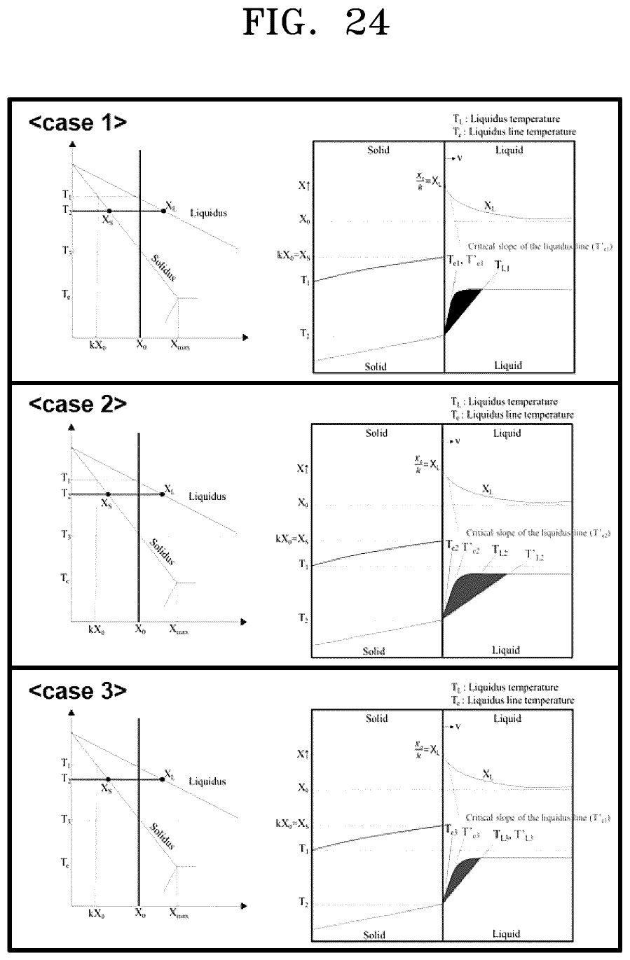

Referring to FIG. 23, the mechanism of the grain refinement and the formation of equiaxed grains effects is shown. First, zirconia (ZrO₂) must be melted using high volume energy density. The molten zirconia is reduced to zirconium and oxygen to combine with aluminum atoms in the molten metal, thereby forming Al₃Zr intermetallic compounds having the metastable phase L1₂ structure. In addition, oxygen atoms combine with silicon atoms and aluminum atoms in the molten metal, thereby forming silicon oxide (SiO₂) and aluminum oxide (Al₂O₃), respectively. In the Inconel 718-zirconia deposition structure at high volume energy density, the occurrence of the heterogeneous nucleation effect is maximized during solidification due to the Al₃Zr intermetallic compound having the metastable phase L1₂ structure having excellent lattice coherence with the face-centered cubic (FCC) matrix, thereby forming equiaxed grains. Here, the volume energy density is 0.0506, the laser power is 250 W, and the scan speed is 1000 mm/min.

On the other hand, in the Inconel 718-zirconia deposition structure at the lowest volume energy density, unmolten zirconia was observed regardless of the region in the deposition structure, and the Al₃Zr intermetallic compound having the metastable phase L1₂ structure having excellent lattice coherence with the face-centered cubic (FCC) matrix was not formed. Therefore, the heterogeneous nucleation effect does not occur during solidification, and columnar grains were formed, like the Inconel 718 deposition structure. Here, the volume energy density is 0.0214, the laser power is 250 W, and the scan speed is 1400 mm/min.

The Marangoni convection (Ma) and the Fourier number (Fo) of the phenomenon occurring during solidification are important factors in the formation of equiaxed grains. In the present invention, single beads of Inconel 718 powder and Inconel 718-zirconia mixed powder were deposited to analyze melt pool shape, thereby calculating the Marangoni convection value and the Fourier number. In addition, the cooling rate (i.e. G×R) and G/R (thermal gradient/solidification rate) values, are estimated using the Marangoni convection value and the Fourier number to analyze microstructural changes under the condition corresponding to the coarse polygonal grains (the laser power of 250 W and the scan speed of 600 mm/min), the condition corresponding to polygonal grains and equiaxed grains (the laser power of 150 W and the scan speed of 600 mm/min), and condition corresponding to fine equiaxed grains (the laser power of 250 W and the scan speed of 1000 mm/min).

The Marangoni convection value is a dimensionless number that represents convection phenomenon caused by changes in surface tension of liquid surface. The Marangoni convection value is caused by changes in temperature and concentration of liquid.

The Marangoni convection value may satisfy the following equation 3:

$$[ Marangoni convection ] = ( dT / d γ ) \times ( w Δ T / μα ) \qquad [ Equation 3 ]$$

Here, T is temperature of a melt pool, γ is surface tension, w is a width of the melt pool, ΔT is difference between maximum temperature and solidus temperature of the melt pool, μ is viscosity of the melt pool, and α is thermal diffusivity of the melt pool.

In the present invention, among equations for the Marangoni convection value, viscosity (μ), thermal diffusivity (α), and width (w) of the melt pool were measured to calculate the Marangoni convection value. Here, the surface tension (γ) and ΔT values were assumed as a constant.

After measuring the melt pool shape, it is observed that the Marangoni convection value increases, as the aspect ratio (Width/Depth, W/D) of the melt pool increases.

As the Marangoni convection value increases, heat transfer by convection in the melt pool increases, but heat transfer by conduction in the melt pool decreases. As the Marangoni convection value increases, the heat transfer by convection becomes the dominant mechanism of heat transfer in melt pool. The convection from high temperature molten metal to low temperature molten metal actively occurs, thereby decreasing thermal gradient (G). In addition, as thermal gradient (G) decreases, the cooling rate (i.e., G×R) and G/R (thermal gradient/solidification rate) decrease, and a growth restriction effect increases, thereby promoting the formation of equiaxed grains.

In the present invention, compared to the condition under which coarse polygonal grains are formed (the condition of the Marangoni convection value of 2.223, the laser power of 250 W, and the scan speed of 600 mm/min) and the condition under which polygonal grains and equiaxed grains were mixed (the condition of the Marangoni convection value of 3.246, the laser power of 150 W, and the scan speed of 600 mm/min), the Marangoni convection value increases under the condition under which fine equiaxed grains were formed (the condition of the Marangoni convection value of 3.475, the laser power of 250 W, and the scan speed of 1000 mm/min).

The Fourier number is a dimensionless number that represents a time scale during heat dissipation process and is used as a measure to compare the heat dissipation rate and heat storage rate of a material. The higher Fourier number, the faster heat dissipation rate is than the heat storage rate.

The Fourier number may satisfy the following equation 4:

$$[ Fourier number ] = α / ( V \times L ) \qquad [ Equation 4 ]$$

Here, α is thermal diffusivity of a melt pool, V is a scan speed, and L is a length of the melt pool.

In the present invention, the scan speed (V) and the length of melt pool (L) were measured by experiments in the Fourier equation. Thermal diffusivity (α) of melt pool was assumed as a constant.

After measuring the melt pool shape, the Fourier number decreases as the scan speed increases and the length of melt pool increases.

As the Fourier number decreases, the heat dissipation rate in the melt pool decreases and the heat storage rate increases. As the Fourier number decreases, the heat dissipation from the melt pool decreases and the heat storage rate increases, thereby increasing the heat stored in the melt pool and decreasing thermal gradient (G) in the melt pool. As thermal gradient (G) decreases, the cooling rate (i.e., G×R) and G/R (thermal gradient/solidification rate) decrease, and a growth restriction effect increases, thereby promoting the formation of equiaxed grains.

In the present invention, compared to the condition under which coarse polygonal grains were formed (the condition of the Fourier number of 0.02645, the laser power of 250 W, and the scan speed of 600 mm/min) and the condition under which polygonal grains and equiaxed grains were mixed (the condition of the Fourier number of 0.01893, the laser power of 150 W, and the scan speed of 600 mm/min), the Fourier number decreases under the condition under which fine equiaxed grains were formed (the condition of the Fourier number of 0.01052, the laser power of 250 W, and the scan speed of 1000 mm/min).

However, thermal gradient (G) may be estimated through the Fourier number, the trend of change in the solidification rate (R) is unknown. This is because thermal supercooling and compositional supercooling cannot be clearly estimated. In addition, since the trend of change in the solidification rate (R) is unknown, effects of the formation of equiaxed grains and changes in microstructure due to the solidification rate (R) cannot be clarified. The reasons are as follows. Changes in thermal supercooling and compositional supercooling may be estimated through thermal gradient (G) and solidification rate (R).

As the Fourier number decreases, the heat dissipation rate decreases, and the heat storage rate increases, thereby decreasing the cooling rate (i.e., G×R). As the cooling rate decreases, solid-state back diffusion becomes active. Thus, the movement of solute elements from the region of solid state to liquid state decreases, thereby relatively decreasing the concentration of the solute elements at the solid/liquid interface. In addition, as the concentration of the solute elements at the solid/liquid interface relatively decreases, equilibrium solidification point at the solid/liquid interface rises, and the slope of equilibrium solidification line decreases. However, since changes in liquidus temperature T_{L} cannot be estimated, changes in thermal supercooling and compositional supercooling cannot be clearly estimated.

Referring to Case 1 of FIG. 24, since the equilibrium solidification line Tₑ₁ corresponding to the slope of the equilibrium solidification point Tₑ₁ at the solidification interface is greater than the liquidus temperature T_{L1}, compositional supercooling occurs, indicated by the black area.

Referring to Case 2 of FIG. 24, compared to Case 1, since the concentrating trend of solute elements at the solidification interface decreases, the equilibrium freezing point Tₑ₂ at the solid/liquid interface increases and the equilibrium solidification line Tₑ₂, corresponding to the slope of the equilibrium solidification point Tₑ₂ at the solidification interface, decreases. Here, if the liquid temperature T_{L2} is sufficiently reduced, the compositional supercooling indicated by the red area may be further increased.

Referring to Case 3 of FIG. 24, compared to Case 1, since the concentrating trend of solute elements at the solidification interface decreases, the equilibrium freezing point Tₑ₃ increases and the equilibrium solidification line Tₑ₃, corresponding to the slope of the equilibrium solidification point Tₑ₃ at the solidification interface, decreases. Here, if the liquidus temperature T_{L3} does not decrease, the compositional supercooling indicated by the red area may be reduced.

For this reason, it may be difficult to estimate a changing trend of thermal supercooling and compositional supercooling. Therefore, it may be difficult to clearly estimate a changing trend of the supercooling at the solid/liquid interface and a changing trend of moving speed of the solid/liquid interface, that is, solidification rate (R).

In conclusion, as the Fourier number decreases, the heat dissipation rate decreases, the heat storage rate increases, and thermal gradient (G) decreases. Thus, since it is difficult to estimate a changing trend of the supercooling at the solid/liquid interface, it may not be difficult to estimate changes in the solidification rate (R). In the case that the solidification rate (R) decreases, when the decrease of thermal gradient (G) is greater than the decrease of the solidification rate (R), overall cooling rate (i.e., G×R) and G/R (thermal gradient/solidification rate) decrease, thereby promoting the formation of equiaxed grains. Therefore, for the condition under which fine equiaxed grains are formed, that is the conditions of the laser power of 250 W and the scan speed of 1000 mm/min, since the decrease of thermal gradient (G) is greater than the decrease of the solidification rate (R), G/R (thermal gradient/solidification rate) decreases. For the condition under which fine equiaxed grains are formed, it is difficult to estimate the solidification rate (R). However, since the decrease of thermal gradient (G) is less than the decrease of the solidification rate (R), G×R increases and G/R decreases.

The behavior of the formation of equiaxed grains and the grain refinement during solidification due to adding zirconia with respect to the volume energy density and G/R (thermal gradient/solidification rate) are described. For the fine equiaxed grains completed solidified, grain growth may occur due to periodic heat input during cooling. Here, the Al₃Zr intermetallic compound may suppress the grain growth, referring to the pinning effect. Therefore, for the deposition structure having zirconia, under deposition process conditions under which Al₃Zr intermetallic compound is formed, since the grain growth is suppressed by the Al₃Zr intermetallic compound even after solidification is completed, fine equiaxed grains may be maintained even at room temperature.

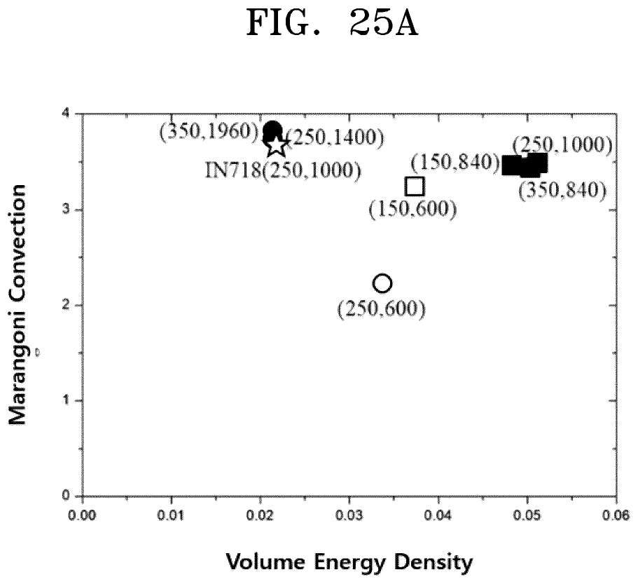

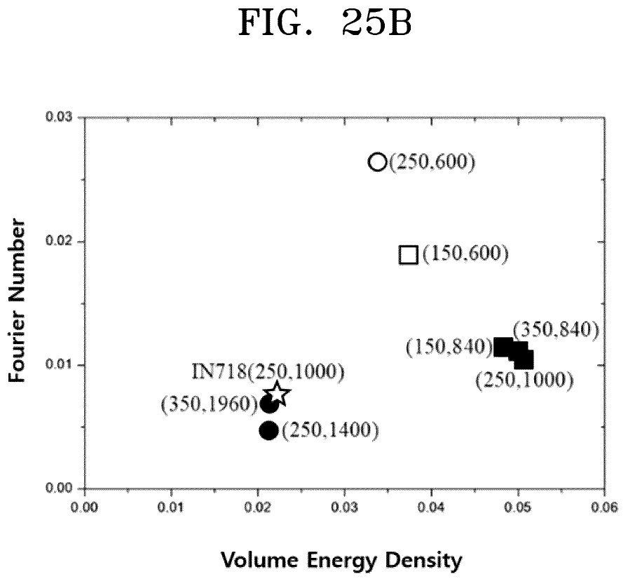

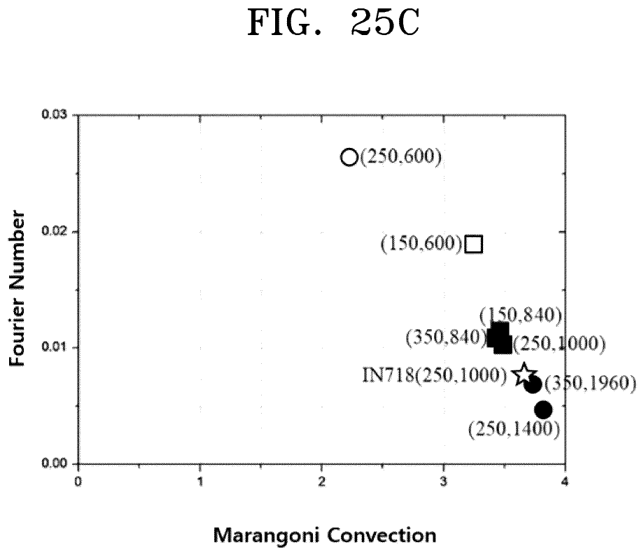

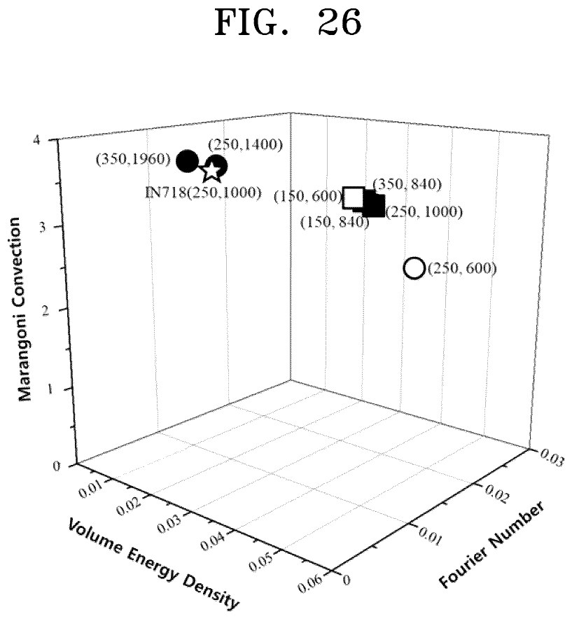

FIGS. 25A to 26 show graphs for deriving correlations for the microstructures of deposition structures formed by a method of controlling microstructure of a nickel-based superalloy directed energy deposition structure, according to an embodiment of the present invention.

In FIGS. 25A, 25B, 25C and 26, each data shows “(laser power, scan speed)”.

Referring to FIG. 25A, 25B, and 25C, two-dimensional graphs for analyzing the grain refinement and the formation of equiaxed grains with respect to the internal variables are shown. Referring to FIG. 25A, the graph shows data with respect to the internal variables, such as the Marangoni convection value versus the volume energy density. Referring to FIG. 25B, the graph shows data with respect to the internal variables, such as the Fourier number versus the volume energy density. Referring to FIG. 25C, the graph shows data with respect to the internal variables, such as the Marangoni convection value versus the Fourier number. The microstructures are shown in FIG. 11D.

Referring to FIG. 26, a three-dimensional graph for the volume energy density, the Marangoni convection value, and the Fourier number by integrating the two-dimensional graphs in FIGS. 25A to 25C is shown. In this graph, since data points are gathered according to the types of the grains, tendency is observed. That is, the data points of the deposition structures of

IN718 (250, 1000, 250), (350, 1960, 179), and (250, 1400, 179) having columnar grains are gathered. The data points of the deposition structures of (150, 840, 179), (250, 1000, 250), and (350, 840, 417) having fine equiaxed grains and the data point of the deposition structure of (150, 600, 250) having a mixed structure of columnar grains and equiaxed grains are gathered. The data point of the deposition structures of (250, 600, 417) having coarse columnar grains is displaced separately and individually.

Here, the data point having “IN718” corresponds to the Inconel 718 deposition structure and the data points without “IN718” correspond to the Inconel-zirconia deposition structure.

Compared with FIG. 14, there is a difference in that the deposition structure of (150, 600, 250) and the deposition structures having fine equiaxed grains are gathered.

Therefore, it is analyzed that the microstructure development factors are derived from the three-dimensional graph constructed with the internal variables such as the volume energy density, the Marangoni convection value, and the Fourier number. That is, the correlation between the microstructure of the deposition structure and the internal variables was derived.

### Conclusion

The microstructural and mechanical properties of Inconel zirconia deposition structure manufactured by the directed energy deposition method were analyzed, and the following conclusions were obtained.

1. In the Inconel-zirconia deposition structure, humping was observed under low laser power conditions, the porosity was less than 1% in all cases except for the condition where lack of fusion occurred, and only gas pore was observed.

2. Under the A7 condition (250 W, 1000 mm/min), contact ratio, Marangoni convection value, and volume energy density were measured to be high. This is due to the melting of the numerous zirconia nanoparticles, which led to the promotion of the grain refinement and the formation of equiaxed grains due to the increase in heat dissipation and cooling rate, and the decrease in G/R (thermal gradient/solidification rate) value.

3. Under the A7 condition (250 W, 1000 mm/min), a metastable L1₂ structure Al₃Zr intermetallic compound was formed due to the heterogeneous nucleation effect and the grain boundary pinning effect, which promoted the grain refinement and the formation of equiaxed grains.

4. The grain refinement and the formation of equiaxed grains led to decrease in the non-uniformity between the surface and interior of the deposition structure, which decreased the anisotropy of the mechanical properties of the A7 (250 W, 1000 mm/min) condition and resulted in an improvement in hardness.

According to the present invention, a method of controlling microstructure of a nickel-based superalloy directed energy deposition structure is provided to obtain microstructural refinement, uniformity, and high hardness.

Inconel 718 deposition structure manufactured by the directed energy deposition (DED) method may experience grain coarsening due to high heat input. Accordingly, there is a risk of deterioration in mechanical properties. In the present invention, the mechanism of the grain refinement and the formation of equiaxed grains of a deposition structure formed by mixed powder having an Inconel 718 powder and a zirconia nano powder using a directed energy deposition method are analyzed, and a method of controlling microstructure of a nickel-based superalloy directed energy deposition structure is provided.

Zirconia nano-powder having an average particle diameter of 200 nm and 2 wt % (weight %) was added to the Inconel 718 powder to form a mixed powder using a swing planetary mixer. Inconel-zirconia deposition structures were formed with mixed powder using the directed energy deposition method with the laser power of 150 W, 250 W, or 350 W, and the laser energy density of 179 J/mm, 250 J/mm, or 417 J/mm as a process variable. In the Inconel-zirconia deposition structure, fine equiaxed grains were dominantly formed at the laser power of 250 W and the scan speed of 1000 mm/min. From the conditions, to analyze the microstructure development factors, a volume energy density, a Marangoni convection value, and a contact ratio are calculated, and their correlation was analyzed. Accordingly, it was confirmed that the grain refinement and the formation of equiaxed grains were promoted as the volume energy density, the Marangoni convection value, and the contact ratio increased. The nucleation behavior due to adding zirconia was analyzed using a transmission electron microscope. It was confirmed that heterogeneous nucleation and the grain boundary pinning effect were induced due to the formation of L1₂ structure Al₃Zr intermetallic compounds, thereby promoting the grain refinement and the formation of equiaxed grains. In addition, it was confirmed that average Vickers hardness increased to in the range of 41 Hv to 49 Hv in all areas including surfaces and interfaces due to the refinement and the anisotropy reduction of the deposition structure. The transition from columnar grains to equiaxed grains was caused by the Al₃Zr intermetallic compounds, and this effect was maximized at the laser power of 250 W and the scan speed of 1000 mm/min.

According to the present invention, by adding zirconia nanoparticles, which are easily available and inexpensive, to a nickel-based superalloy, it is possible to realize the grain refinement and the formation of equiaxed grains, anisotropy reduction, and hardness improvement of the Inconel-zirconia deposition structure formed using a directed energy deposition method.

In addition, according to the present invention, it was confirmed that any correlation between the microstructure of the nickel-based superalloy directed energy deposition structure and process variables was not established. Instead, a correlation with respect to the internal variables was established. Thus, using the correlation, a target nickel-based superalloy directed energy deposition structure having a target microstructure may be formed by setting internal variables including at least one of a volume energy density, a Fourier number, a Marangoni convection value, and a contact ratio.

The above-described effects of the present invention are merely examples, and the scope of the present invention is not limited thereto.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A method of controlling microstructure of a nickel-based superalloy directed energy deposition structure, comprising:
providing a mixed powder comprising a nickel-based superalloy powder and a zirconia nano-powder;
forming a nickel-based superalloy directed energy deposition structure by performing directed energy deposition with the mixed powder using a laser with a process variable; and
establishing a correlation between microstructure and an internal variable of the nickel-based superalloy directed energy deposition structure.

2. The method of claim 1, further comprising:
forming a target nickel-based superalloy directed energy deposition structure having a target microstructure by setting the internal variable using the correlation.

3. The method of claim 2, wherein the forming a target nickel-based superalloy directed energy deposition structure is performed by deriving a process variable from the internal variable, and performing directed energy deposition with the mixed powder under the derived process variable to form the target nickel-based superalloy directed energy deposition structure.

4. The method of claim 1, wherein the process variable comprises at least one of a laser power, a scan speed, and a laser energy density during the performing directed energy deposition.

5. The method of claim 1, wherein the internal variable comprises at least one of a volume energy density, a Fourier number, a Marangoni convection value, and a contact ratio.

6. The method of claim 5, wherein the volume energy density satisfies the following equation:
$$[ volume energy density ] = [ laser energy density ] / [ volume of melt pool ] .$$

7. The method of claim 5, wherein the volume energy density is in the range of more than 0 J/mm³ to equal to or less than 0.1 J/mm³.

8. The method of claim 5, wherein the contact ratio satisfies the following equation:
$$[ contact ratio ] = [ area of melt pool contacting parent material ] / [ total area of melt pool ] .$$

9. The method of claim 5, wherein the contact ratio is in the range of more than 0 to less than 1.

10. The method of claim 5, wherein the Marangoni convection value satisfies the following equation:
$$[ Marangoni convection ] = ( dT / d γ ) \times ( w Δ T / μα )$$
(Here, T is temperature of a melt pool, γ is surface tension, w is a width of the melt pool, ΔT is difference between maximum temperature and solidus temperature of the melt pool, μ is viscosity of the melt pool, and α is thermal diffusivity of the melt pool).

11. The method of claim 5, wherein the Marangoni convection value is in the range of more than 0 to equal to or less than 5.

12. The method of claim 5, wherein the Fourier number satisfies the following equation:
$$[ Fourier number ] = α / ( V \times L )$$
(Here, α is thermal diffusivity of a melt pool, V is a scan speed, and L is a length of the melt pool).

13. The method of claim 1, wherein a microstructure of the nickel-based superalloy directed energy deposition structure comprises at least one of a columnar grain structure, an equiaxed grain structure, a mixed structure of columnar grains and equiaxed grains, and an amorphous structure.

14. The method of claim 2, wherein a target microstructure of the target nickel-based superalloy directed energy deposition structure comprises at least one of a columnar grain structure, an equiaxed grain structure, a mixed structure of columnar grains and equiaxed grains, and an amorphous structure.

15. The method of claim 1, wherein the nickel-based superalloy powder has a first average particle size, and the zirconia nano-powder has a second average particle size smaller than the first average particle size.

16. The method of claim 1, wherein the nickel-based superalloy powder has an average particle size in the range of 45 μm to 150 μm, and the zirconia nano-powder has an average particle size in the range of 20 nm to 200 nm.

17. The method of claim 1, wherein the mixed powder comprises the nickel-based superalloy powder in the range of 98 wt % to 99 wt % and the zirconia nano-powder in the range of 1 wt % to 2 wt %.

18. The method of claim 1, wherein the nickel-based superalloy powder comprises, based on the total weight of the nickel-based superalloy powder, 50 wt % to 55 wt % of nickel (Ni), 17 wt % to 21 wt % of chromium (Cr), 4.75 wt % to 5.50 wt % of niobium (Nb), 2.8 wt % to 3.30 wt % of molybdenum (Mo), 0.65 wt % to 1.15 wt % of titanium (Ti), 0.20 wt % to 0.80 wt % of aluminum (Al), 0.1 wt % to 1 wt % of cobalt (Co), and a remainder including iron and inevitable impurities. 19 The method of claim 1, wherein the forming the nickel-based superalloy directed energy deposition structure is performed with a laser power in the range of 100 W to 500 W and a laser scan speed in the range of 200 mm/min to 2000 mm/min.

20. A method of controlling microstructure of a nickel-based superalloy directed energy deposition structure, comprising:
providing a powder;
forming a directed energy deposition structure by performing directed energy deposition with the powder using a laser with a process variable; and
establishing a correlation between microstructure and an internal variable of the directed energy deposition structure.
